(19) United States
(12) Patent Application Publication
(10) Pub. No.: US 2015/0076903 A1
(43) Pub. Date: Mar. 19, 2015

(54) CONTROLLING APPARATUS, POWER CONVERTING APPARATUS, CONTROLLING METHOD, COMPUTER-READABLE RECORDING MEDIUM AND CONTROLLING SYSTEM

(71) Applicant: KABUSHIKI KAISHA TOSHIBA, Tokyo (JP)

(72) Inventors: Fumiaki Kanayama, Kawasaki (JP); Yuusuke Kouno, Tokyo (JP); Masayuki Nogi, Tokyo (JP); Yasuyuki Nishibayashi, Kawasaki (JP); Ikuya Aoyama, Yokohama (JP)

(21) Appl. No.: 14/486,110

(22) Filed: Sep. 15, 2014

(30) Foreign Application Priority Data
Sep. 19, 2013 (JP) 2013-194647

(51) Int. Cl. H02M 7/44; H02M 1/02

(52) U.S. Cl. CPC H02M 7/44; H02M 1/02
USPC 307/24; 307/31

(57) ABSTRACT

According to one embodiment, a controlling apparatus includes a power phase controlling unit to control the phase of the power to be output to the power line by the power converting apparatus, based on the synchronous signal, and when a disruption of the synchronous signal is detected, control the phase of the power to be output to the power line by the power converting apparatus, based on the synchronous signal received before the disruption. The controlling apparatus includes a communication controlling unit to control the communicating unit such that, for information to determine a master that sends the synchronous signal, the communicating unit performs either one of a receiving from the controlling apparatus for the other power converting apparatus and a sending to the controlling apparatus for the other power converting apparatus, while the power phase controlling unit performs the control based on the synchronous signal received before the disruption.

### CROSS-REFERENCE TO RELATED APPLICATIONS

This application is based upon and claims the benefit of priority from Japanese Patent Application No. 2013-194647, filed Sep. 19, 2013; the entire contents of which are incorporated herein by reference.

### FIELD

Embodiment described herein relate generally to a controlling apparatus, a power converting apparatus, a controlling method, a computer-readable recording medium and a controlling system.

### BACKGROUND

In some cases, multiple power converting apparatuses to output alternating current voltage are connected in parallel and are operated. In order to increase alternating current power using the alternating current powers to be output by the multiple power converting apparatuses, it is necessary to synchronize the phases of the output alternating current powers. This is because, when the multiple power converting apparatuses connected in parallel output alternating current voltages whose phases are not synchronized, a cross current is generated, resulting in problems such as a decrease in efficiency.

### BRIEF DESCRIPTION OF THE DRAWINGS

FIG. 1 is a first example of the configurations of the power converting systems according to the embodiments of the present invention.

FIG. 2 is a second example of the configurations of the power converting systems according to the embodiments of the present invention.

FIG. 3 is a first example of the connection configurations of the power converting apparatuses according to the embodiments and the peripheral apparatuses.

FIG. 4 is a second example of the connection configurations of the power converting apparatuses according to the embodiments and the peripheral apparatuses.

FIG. 5 is a first example of the configuration on the output side of the power converting apparatus 10.

FIG. 6 is a second example of the configuration on the output side of the power converting apparatus 10.

FIG. 7 illustrates the operation sequence (1-B) of the above examples.

FIG. 8 is a second example of the operation sequence when, in the configuration example of FIG. 3, the master apparatus 11 stops the operation.

FIG. 9 is a schematic block diagram showing the configuration of the power converting apparatus 10 according to the first embodiment.

FIG. 10 is a schematic block diagram showing the configuration of the controlling unit 102 according to the first embodiment.

FIG. 11 is a schematic block diagram showing the configuration of the phase synchronization circuit unit 401 according to the first embodiment.

FIG. 12 is a schematic block diagram showing the configuration of a power converting apparatus 10b according to the second embodiment.

FIG. 13 is a schematic block diagram showing the configuration of the controlling unit 102b according to the second embodiment.

FIG. 14 is a schematic block diagram showing the configuration of the phase synchronization circuit unit 401b according to the second embodiment.

FIG. 15 is a schematic block diagram showing the configuration of the power converting apparatus 10c according to the third embodiment.

FIG. 16 is a schematic block diagram showing the configuration of the controlling unit 102c according to the third embodiment.

FIG. 17 is a schematic block diagram showing the configuration of the phase synchronization circuit unit 401c according to the third embodiment.

FIG. 18 is a schematic block diagram showing the configuration of a power converting apparatus 10d according to the fourth embodiment.

FIG. 19 is a schematic block diagram showing the configuration of the controlling unit 102d according to the fourth embodiment.

FIG. 20 is a schematic block diagram showing the configuration of the phase synchronization circuit unit 401d according to the fourth embodiment.

FIG. 21 is a schematic block diagram showing the configuration of a power converting apparatus 10e according to the fifth embodiment.

FIG. 22 is a schematic block diagram showing the configuration of the controlling unit 102e according to the fifth embodiment.

FIG. 23 is a schematic block diagram showing the configuration of the phase synchronization circuit unit 401e according to the fifth embodiment.

FIG. 24 is an example of the communication content for designating the duration of accelerating and decelerating.

FIG. 25 is an example of a graph that the master, the controller or the like distributes to the other inverters through communication and that shows a schedule of the velocity change after the time point of the communication occurrence.

FIG. 26 is an example of a connection diagram of the main power line and secondary power line of the power converting apparatus according to the sixth embodiment.

FIG. 27 is a diagram for explaining a process of the power converting apparatus 10 according to the sixth embodiment.

FIG. 28 is a diagram for explaining a process of a power converting apparatus 10 according to the seventh embodiment.

FIG. 29 is a diagram showing an information flow from the disruption of the synchronous signal to the start of the communication for the master-slave reconfiguration.

### DETAILED DESCRIPTION

According to one embodiment, a controlling apparatus to control a power converting apparatus that converts power and outputs the converted power to a power line, the controlling apparatus includes a communicating unit to communicate with at least one other controlling apparatus for a power converting apparatus that outputs power to the power line. The controlling apparatus includes a synchronous signal unit to receive a synchronous signal that is a basis of a phase of the output power by the power converting apparatus. The controlling apparatus includes a power phase controlling unit to control the phase of the power to be output to the power line by the power converting apparatus, based on the synchronous signal, and when a disruption of the synchronous signal is detected, control the phase of the power to be output to the power line by the power converting apparatus, based on the synchronous signal received before the disruption. The controlling apparatus includes a communication controlling unit to control the communicating unit such that, for information to determine a master that sends the synchronous signal, the communicating unit performs either one of a receiving from the controlling apparatus for the other power converting apparatus and a sending to the controlling apparatus for the other power converting apparatus, while the power phase controlling unit performs the control based on the synchronous signal received before the disruption.

Hereinafter, embodiments of the present invention will be explained with reference to the drawings. In power converting systems according to the embodiments, power converting apparatuses are equipped with communication functions, and thereby, an autonomous coordination type control is performed among multiple power converting apparatuses. The power converting system implements the automatic recognition of an addition of a power converting apparatus for increasing the output and a stop by a failure, and the automation of the maintenance, allowing for a prevention of human errors and a flexible installation and operation of the apparatus.

In the embodiments, a power converting apparatus (here, an inverter, as an example) to send a synchronous signal that is the basis of the phases of the output powers of the multiple power converting apparatuses (here, inverters, as an example) is referred to as a master apparatus, and the other power converting apparatuses (here, inverters, as an example) to receive the synchronous signal and synchronize the output voltages with the synchronous signal are referred to as slave apparatuses.

Further, in the embodiments, each power converting apparatus includes a controlling apparatus, and the controlling apparatus, according to circumstances, operates as a master that sends the synchronous signal, or operates as a slave that receives the synchronous signal.

In the embodiments, a controlling apparatus to send the synchronous signal is referred to as a master or a controlling apparatus to operate as a master, and a controlling apparatus to receive the synchronous signal is referred to as a slave or a controlling apparatus to operate as a slave.

### <Information Communication: UPnP>

In the field of information communication, there is a concept called Plug-and-Play, as a concept about the addition and removal of an apparatus. Examples of means for implementing Plug-and-Play include the use of the UPnP protocol. Once a UPnP-enabled apparatus is powered ON and participates in a communication network, firstly, it sends a message “ssdp: alive”, which is a message for publicizing the existence of its own apparatus to other peripheral UPnP-enabled apparatuses, to a multicast address. Thereafter, the “ssdp: alive” is sent every certain period, for showing that its own apparatus continues working.

When the apparatus is stopped, a message “ssdp: byebye” is sent to the multicast address, and thereby, the stop of its own apparatus is known to the other apparatuses. In case the apparatus unpredictably stops or in case it unpredictably drops off from the communication network, the apparatuses always monitor the “ssdp: alive”, and, if this message is not sent for long periods, judge that the apparatus in question has stopped although the “ssdp: byebye” is not sent.

Thus, the UPnP has a characteristic in that the addition and removal of an apparatus can be freely performed, but, on the other hand, has a problem in that when the apparatus unpredictably stops, it takes a long time for the other peripheral apparatuses to detect the stop of the apparatus in question. This causes the disorder of synchronization, particularly, when the outputs of multiple inverters are synchronized. Therefore, in the case where the UPnP is applied, with no change, to multiple inverters that coordinately operate, there is a problem in that when the master stops by failure, it take time for the remaining slaves to detect the stop of the master.

### <Conventional Multi-Coordinate Operation Type Inverter>

Meanwhile, in multi-coordinate operation type inverters that are conventionally present, there is an inverter that has a function to implement the alternation of the master when the master stops. Such an inverter has a scheme in which the slaves monitor the feed-back from, for example, an ammeter provided to the output port of the master inverter, and when the feed-back value becomes an abnormal value such as 0, recognize that the master has stopped, and then start the alternation of the master. The use of such a scheme allows the other inverters to quickly detect the stop of the inverter, but, on the other hand, cannot deal with the additional operation of an inverter.

Responding to such a problem, the power converting apparatuses according to the embodiments implement the addition of a power converting apparatus and the alternation function of the master, by using communication. Therewith, the power converting apparatuses according to the embodiments have a scheme of always monitoring the synchronous signal when operating as a slave and quickly detecting the stop of the master when the synchronous signal is disrupted, and when the master stops, can immediately start to select a new master using communication.

First, application examples of the embodiments will be explained.

### Application Example 1

### Micro Grid

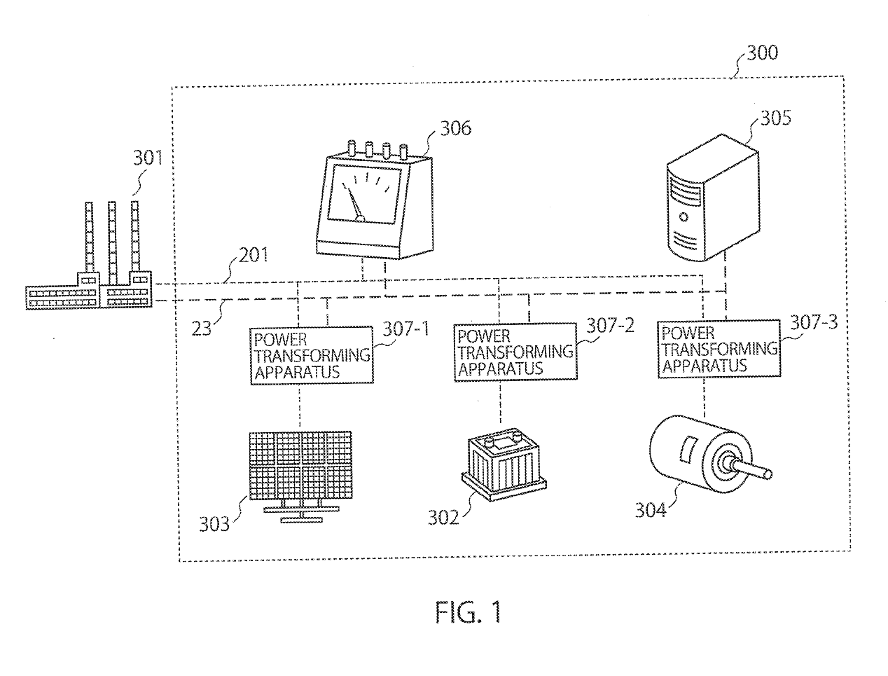

FIG. 1 is a first example of the configurations of the power converting systems according to the embodiments of the present invention. As an application example of the power converting system, a micro grid is possible, concretely, a small or middle scale power system in a general household, a store, a factory, a building, a station, a commercial facility, or the like is possible. A micro grid (hereinafter, merely referred to as a system, also) 300 includes, as an example, a power generating apparatus 303, a power storing apparatus 302, a load 304, a power converting apparatus 307, a power line 201 and information communication line 23 that connect them, and the like, as basic elements. FIG. 1 shows an example in which three power converting apparatuses (307-1, 307-2, 307-3) are present, as an example. Here, the number of power converting apparatuses may be two or less, or may be four or more. Thus, the power converting systems according to the embodiments include at least multiple power converting apparatuses.

Besides these, various sensors 306, an EMS server 305, other power-related apparatuses and the like may be present. Each constituent element has a communication function, allowing for an advanced control as the whole system and a coordination with an external system.

In FIG. 1, which is an example of the micro grid 300, the system is connected with a utility grid 301 through the power line 201, and can receive the power supply from the utility grid 301. Further, when surplus power is produced in the system, it is possible to reversely perform power transmission (reverse power flow), and also, it is possible to simultaneously consume the power produced in the system and the power supplied from the utility grid 301. Further, the system may be independent of utility grids. In the following, various elements constituting the micro grid 300 will be exemplified.

### <Power Generating Apparatus>

The power generating apparatus 303 is an apparatus that converts various forms of energy into electric energy. Examples thereof include a solar power generator (PV Photovoltaic) using light energy, a hydroelectric or wind-power generator using fluid energy such as water flow or wind flow, a thermal power generator to convert chemical energy such as fossil fuel into power, a geothermal power generator using heat present in nature, a power generator by vibration or tidal power, and others. Similarly, a nuclear power generator can be also included, although it is safe to say that there is almost not a likelihood of the use in a small or middle scale system.

In many cases, the power generating apparatus has a configuration in which various energy forms are temporarily converted into rotary motion and then power is obtained using a synchronous machine, but, there is a power generating form that does not depend on kinetic energy, such as a solar power generator. The apparatus may adopt a form to have multiple functions concurrently, such as an apparatus that serves as a water heater and a gas fired power generator concurrently.

### <Power Storing Apparatus>

The power storing apparatus 302 is an apparatus that converts electric energy into another energy form and preserves it, and is typically a battery. It can be said that a storage battery or an electric automobile (EV: Electric Vehicle) equipped with a storage battery is a typical power storing apparatus, but a dry battery, which is under the premise that it performs only discharge after production, may be included.

In some cases, for the management of the charge and discharge speed, battery deterioration and life, the power storing apparatus 302 is equipped with a controlling system configured by power transforming components such as a microcomputer, a regulator and an inverter. The power transforming or controlling system is called a PCS (Power Conditioning System). Further, a storage battery integrated with the PCS is sometimes called a BESS (Battery Energy Storage System). In some cases, the PCS is attached to not only a storage battery but also a solar power generator, other small-size power generators and the like.

Application examples of the power storing apparatus 302 include a water tower that, in a broad sense, can be interpreted to preserve electric energy as potential energy, an uninterruptible power source apparatus, and the like. Also, a flywheel or the like that allows for derivation of power from accumulated kinetic energy can be interpreted as a kind of power storing apparatus.

### <Load>

The load 304 is an apparatus that consumes power and an apparatus that converts electric energy into another energy form. In many cases, the electric energy is converted directly or indirectly into thermal energy.

As representative examples of the load, a motor, a light, a heating apparatus, a computer and the like are possible. In a micro grid, a motor is often present as a combination with another apparatus such as an electrical household appliance, an elevator or an escalator, or as a form in which an additional function is added.

When the load is a motor, power is converted into dynamic or kinetic energy to be consumed. On this occasion, in some cases, the dynamic force generated by the motor is directly utilized as driving force. Alternatively, in some cases, the conversion of the motion speed or direction, the shift of the rotation axis, the rotation-linear motion conversion, the divergence or combination of kinetic energy or the like is performed through a dynamic force converting device such as a gear wheel. It is possible that the whole dynamic force system including the motor and the dynamic force transmitting and dynamic force converting mechanisms is regarded as the load of the system.

### <Power Converting Apparatus>

The power converting apparatus (also referred to as the power transforming apparatus) 307 means an apparatus, such as an inverter, a converter or a voltage inverter (transformer), that converts direct current/alternating current, voltage, current, frequency, the number of phases or the like while there is no or little power consumption by the apparatus itself. The inverter, typically, is an apparatus that converts a direct current power source into an alternating current power source, but some inverters have a function to convert an alternating current power source into a direct current power source by switching the operation mode. Also, apparatuses such as a circuit breaker or a power router, which perform the break or alteration of a power transmitting path, can be seen as power converting apparatuses in a broad sense. In this document, the term “inverter” is sometimes used as a word that means the whole of the power converting apparatus.

### <Power Line, Power Transmitting Facility>

The power line 201 is a conducting wire for transmitting power among the respective apparatuses of the power generating apparatus 303, the power storing apparatus 302, the power converting apparatus 307 and the load 304. A power line corresponding to a single-phase voltage of 100 V is often used in a household, a building and an office, and a power line corresponding to a three-phase voltage of 200 V is often used for the connection with a grid. A power line corresponding to a further high voltage is used in the root side of a grid. In the system, it is common to use the power lines corresponding to the above phase numbers and voltages, but only the standard lines in conformity with this are not always used.

### <Communication, Controller>

All the apparatuses present in the system can be equipped with a communication function. For example, the PCS of the storage battery, by being equipped with a communication function, can obtain, for example, a function to inform the other apparatuses about the remaining capacity of its own apparatus. Further, information aggregating apparatuses such as a HEMS (Home Energy Management System) server, in which communication is a main function, a BEMS (Building Energy Management System) server, a controller, a gateway, a personal computer and a server can be also important constitute elements of the micro grid. The information aggregating apparatus can analyze the information collected from apparatuses such as the storage battery and various sensors, and can perform the optimization of the energy demand and supply in the system, the coordinate operation and the centralized control.

Further, there is also a concept of demand response in which the system communicates with an EMS (Energy management System) server (CEMS: Community Energy Management System) presiding over a community, or a power company, through the HEMS server, the gateway or the like, and regulates the energy as the whole community. As the information communicating apparatus, other than the apparatuses exemplified above, there are a LAN hub to branch Ethernet® cables for a wired LAN (Local Area Network), a wireless LAN access point (AP), and the like.

As the communicating means, the TCP/IP communication by a wired LAN using the Ethernet® and the TCP/IP communication by a wireless LAN are widely distributed, but it is allowable to be Bluetooth®, Zigbee®, PLC (Power Line Communication) or the like. Besides these, communication standards or protocols such as CAN (Controller Area Network) and RS232C, or communication means such as a communication using light or sound waves is possible. As the communicating means to be used in the present invention, any of these means may be used. Further, the communicating medium to be used here can be regarded as a part of the system in a broad sense.

### <Sensor>

The system can include all kinds of sensors. Examples thereof include a smart meter, a voltmeter, an ammeter, a temperature sensor and the like. These sensors can be incorporated in an apparatus such as an inverter, can operate as external sensors of an apparatus such as an inverter by including a communication function, or can be utilized for the control of the whole system by configuring a sensor network.

### <Others (UPS, Instantaneous Voltage Drop Compensating Apparatus and the Like)>

Besides the above, examples of the constituent elements of the micro grid include an instantaneous voltage drop compensating apparatus, an uninterruptible power source apparatus (UPS), a reactive power compensating apparatus (STATCOM), and the like. These can be seen as a kind of the power storing apparatus or the power converting apparatus. Here, in the above apparatuses, the roles are not necessarily partitioned clearly. For example, the synchronous machine can be utilized both as a power generator and as a load. Further, it can be said that the storage battery integrated with the PCS is a power storing apparatus, and at the same time, is an information communicating apparatus.

### Application Example 2

### Grid Interconnection

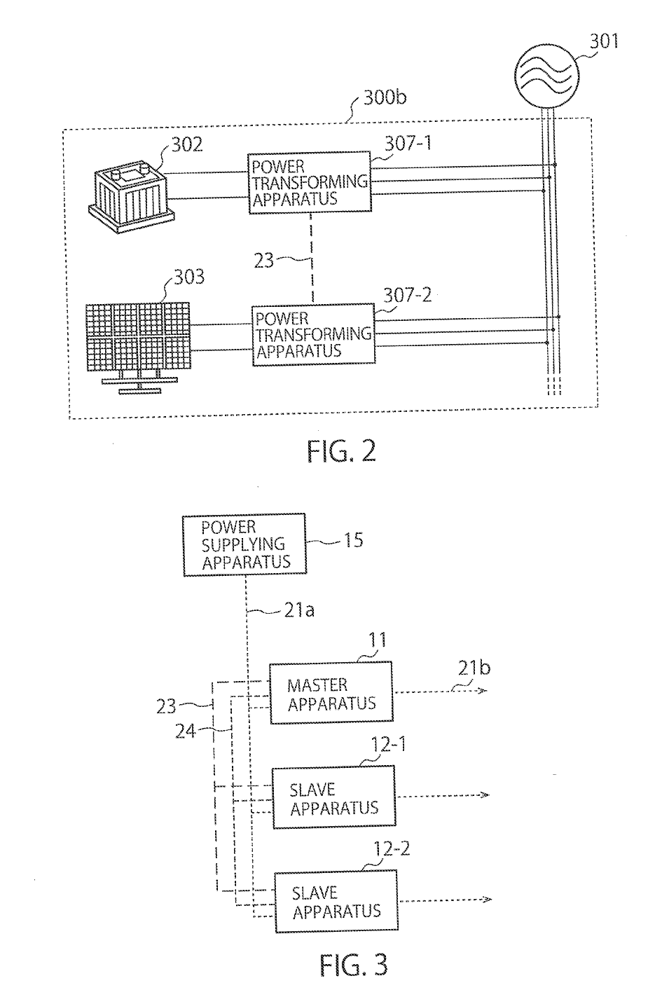

FIG. 2 is a second example of the configurations of the power converting systems according to the embodiments of the present invention. As an application example, there is an application and use for a power converting system 300b in which multiple grid interconnecting inverters are operated. To a utility grid 301, a variety of small to large scale power generating apparatuses 303 and power storing apparatuses 302 are connected through power converting apparatuses 307. The power converting apparatus 307 is a grid interconnecting inverter, for example.

In many cases, a special load or the like is not provided between the grid interconnecting inverter and the utility grid. The inverter and the utility grid are directly connected, and a sensor such as a voltmeter is used. The whole utility grid is managed by small to large scale EMSs, power companies, aggregators and others. The grid interconnecting inverter, which is an inverter to supply power to a grid as an alternating current power output, is installed particularly in mega solar stations, small or middle scale power stations or power storing facilities, or the like, and besides these, is installed in a great variety of palaces such as a household, a building, facilities such as a factory, or a micro grid, to be utilized.

The output voltage has a great range, for example, a single-phase voltage of 100 V, and a three-phase voltage of 200 V. The output is controlled in accordance with the voltage and frequency of the utility grid 301, and the power is exchanged. A grid interconnecting system having a storage battery use, and the like support both forward power flow and reverse power flow. In such a system, each apparatus can have a communication function, and exchanges variety sorts of data such as power data using communication.

Similarly to the above described micro grid, in some cases, a power converting apparatus, a power generating apparatus, a power storing apparatus, and other various apparatuses are present. Particularly, the presence of a controller to control and manage the whole system allows for a comprehensive control of the system. In the embodiments, according to such an application example, the multiple power converting apparatuses perform a grid interconnection while matching the waveforms of the output voltages and currents in a synchronized manner.

### Application Example 3

### Railway, Elevator, Industrial Use

In the power converting apparatuses according to the embodiments, the application to a system for a railway vehicle, an elevating machine, a FA or the like is also possible. In the above system, multiple inverters, motors or others are used in an autonomous coordination manner or under the control of a controller, while performing communications. In industrial use, as the communication standard, communication standards such as RS-485 and CAN, as well as serial communications such as RS-232C are often utilized. Besides these, standards such as Ethernet®, Ethernet®/IP using IP, and EtherCAT are also utilized. According to such an application example, the multiple inverters operate while matching the waveforms of the output alternating current voltages in a synchronized manner, or the multiple motors to be controlled by the inverters operate while matching the rotation frequencies and rotation angles or while performing a shift by a certain angle.

### <Meaning of Synchronization of Inverter>

In the power converting apparatuses according to the embodiments, it is intended that multiple power converting apparatuses equipped with an equivalent function are combined and used. Naturally, the power converting apparatus according to the present invention can be used alone, but in that case, the power converting apparatuses according to the embodiments do not exert the merits

As the power converting apparatus herein, an inverter is mainly intended, but the present invention is not limited to the application to an inverter. The power converting apparatus, which relates to alternating current voltage and alternating current, may be an apparatus that converts power into power, or an apparatus that converts power into another energy form, information or the like.

Further, similarly to an inverter, a controller, an EMS server, various sensors and others can send and receive a synchronous signal, and therefore, the embodiments can be applied to all the apparatuses exemplified above.

### <Basic Explanation of Inverter>

The embodiments relate to, particularly, the synchronization of the alternating current outputs of multiple voltage inverters that are connected in parallel. Here, as an example, the inverter includes a DC power source unit, an electricity controlling unit, a gate drive signal generating unit and a power converting unit, as main constituent elements. The power converting unit includes a gate part and a filter part.

The DC power source unit provides a DC voltage to the gate part. According to circumstances, the DC power source is an input from the exterior, obtains a DC voltage by rectifying an AC input, or includes a chopper circuit for performing a step-up or step-down of an input DC or AC voltage to a desired voltage.

The electricity controlling unit generates a command value corresponding to a target value that is a targeted output value of the inverter (for example, a targeted output power or output voltage of the inverter) and a feed-back value (for example, an actual value of the inverter). The command value is time-series data for determining a duty ratio of a gate drive signal described later.

The gate drive signal generating unit generates the gate drive signal from comparison between the command value and a carrier wave. The gate drive signal generated here is input to a power semiconductor device of a SiC, an IGBT or the like, which configures the gate part, and the switching of the DC voltage is performed.

From the gate part, the voltage is output as a pulse waveform with a high frequency that is based on the frequency of the carrier.

The filter part removes high frequency noises from the high frequency pulse that is output from the gate part, and therewith shapes the waveform into a sine wave.

When being connected with a load insusceptible to high frequency noises, such as a motor, in some cases, the output port of the inverter is directly connected with the input port of the load without the filter part. Further, when the output of the inverter is interconnected with a grid, in some cases, a control for zeroing the reactive power is performed using the inductance of the filter, the inductance of a reactor or pole-mounted transformer that is separately provided, or the like.

### <Unitization of Inverter and Merit of Multiple Parallel Operation>

There is a technique of obtaining a power converting system that, by connecting multiple inverters in parallel, implements an output resulting from summing the output currents of the individual inverters. Ideally, this power converting system can be handled as a single large output inverter, from the outside. A merit of such a technique is that an output equivalent to a high capacity inverter having a desired output rating can be implemented by combining low capacity inverters. This leads to an industrial advantage of achieving a cost-cutting by the mass production of standard products, because the output can be regulated by the combination of existing inverters, even when the acquisition or production of a high capacity inverter is difficult, or without specially producing or preparing an inverter for each desired rating.

### <Necessity of Synchronization of Inverter (Fundamental Wave Synchronization)>

When intending a large output by the power converting system that is formed by connecting multiple inverters in parallel and outputting an alternating current, it is necessary to match the phases of the alternating current voltage outputs of the individual inverters. If the phases are not exactly synchronized, a cross current corresponding to a voltage difference resulting from the phase difference is generated.

When the cross current is generated, a current equal to or greater than the proper output current is generated, and therefore, there is a fear of causing overcurrent or heat generation.

For the above reason, when multiple inverters are connected in parallel and are operated, it is necessary to synchronize the phases of the output alternating current voltages of the inverters. For performing the synchronization, one apparatus to keep a timing of the basis is provided for a group.

Here, in the embodiments, the master apparatus and the slave apparatus are not limited to only the power converting apparatus, and another apparatus present in the system may be the master apparatus or the slave apparatus.

### <Fundamental Wave Synchronization by Pulse Signal>

In the embodiments, the synchronous signal, as an example, is a signal in which a low-level voltage and a high-level voltage higher than the low-level are repeated alternately and periodically (hereinafter, referred to as a pulse signal). One of methods for synchronizing the outputs of the inverters according to the embodiments is a method in which one of the multiple power converting apparatuses becomes the master apparatus to generate the pulse signal and the other power converting apparatuses become the slave apparatuses to receive the pulse signal from the master apparatus. In this method, the pulse voltage output from the master is input to each controlling circuit of the slaves as the synchronous signal, and the controlling circuit holds the period using a PLL (Phase Locked Loop) and therewith achieves the synchronization of the output.

### <Utilization of Rising>

When a pulse waveform is used as the synchronous signal, as an example, the master generates the signal waveform so as to match the rising of the pulse with the moment (zero cross) when the voltage becomes 0 in the process in which the output alternating current voltage switches from the negative to the positive. Then, the slave of the signal receiving side, as an example, performs such a phase control that the output alternating current voltage becomes the zero cross in accordance with the moment of the rising of the pulse waveform.

In the above example, the synchronization is performed utilizing the rising of the pulse, but a case of using the trailing of the pulse, and a method of using both the rising and the trailing are possible. The embodiments can be applied to any case.

### <Generation of Pulse, Grid Interconnection and Independence, Motor Drive>

When the power converting system is interconnected with a grid, the master reads the change in phase from the grid voltage using a voltage sensor, and based on this, generates the pulse signal. When operating independently of a grid and performing a grid-like output to the load, the power converting system counts 50 Hz or 60 Hz with a control microcomputer based on a timer included in the master, and generates the signal. Similarly, when the master, such as a motor drive, performs the frequency control of the load, or when the frequency is arbitrary, the master generates the signal based on the timer or counter of its own apparatus.

### <Synchronous Signal Besides Pulse, Frequency, Frequency Divider/Adder>

Using a pulse voltage waveform as a timing transmission signal is one of the most common techniques, but, needless to say, the present invention can be configured even when using another signal. For example, a pulse current can be used, and as a waveform, a triangular wave, a sine wave, and other waveforms can be used.

The frequency of the waveform does not need to match with the frequency of the output. For example, it is allowable to be a method in which for an output of 50 Hz, the pulse waveform is sent at 10 Hz, and the slave, after receiving the synchronous signal, obtains the timing of 50 Hz using a frequency divider in the internal circuit. Particularly, in the grid interconnection inverter, the frequency to be used is limited to 50 Hz or 60 Hz. Therefore, by selecting 10, which is one of common divisors between 50 and 60, as the frequency of the synchronous signal and being combined with a frequency divider that can change the division ratio, it is possible to support the two frequencies by a single kind of synchronous signal. Alternatively, by selecting 300, which is one of common multiples between 50 and 60, as the frequency of the synchronous signal and concurrently using an adder that counts the signal period, it is possible to obtain the same effect.

In the communication between the master and the slave, the master records a sending time in a communication message. The slave, when receiving it, reads the sending time, and thereby, can match the timer of its own apparatus with the timer of the master and can generate the output waveform based on the timer. Thereby, it is possible to implement the output synchronization among the multiple inverters. Data to be written in a sending message do not have to be a sending time, and for example, may be the combination between the frequency of the output and the lapse time from the zero cross for the output at the time of sending, or the like. Further, without matching the timer with the master, the slave may adopt a timing management way of determining the deviation between the timer of the master and the timer of its own apparatus.

### <Transmission of Signal, Wire/Wireless>

The generated pulse signal is output through the output port of a DAC (Digital Analog Converter) or the like included in the control microcomputer, and is distributed to the slaves using a signal line. On the slave side, the synchronous signal is input to the control microcomputer or peripheral circuits, and the synchronization of the output waveform is performed. On this occasion, it is allowable to go through a circuit to perform the insulation protection using a photo-coupler or the like, or other functional circuits. Although the signal line may be a mere conducting wire, it is preferable to use a noise suppression wire such as a coaxial cable or a twisted pair cable. In addition, the transmitting means of the pulse may be an optical communication or a wireless communication, and when anti-noise measures or insulation measures are sufficient or unnecessary, a filter circuit, an insulation circuit or the like may be omitted.

### <Number of Phases>

In the case where the output is a single-phase, a synchronous signal in which the timing is matched with the sine wave of the output of the master may be used. In the case of a three-phase, there are, for example, a method in which three kinds of signal lines are used, a method in which the three phases are secured by two kinds of synchronous signals and the difference thereof, and a method in which, from a single synchronous signal, synchronous timings whose phases are deviated from each other by 120 degrees are generated and held in the controlling circuit of the slave, and are devoted for the outputs of the three phases. The embodiments can be implemented by any method. Further, the same goes for the case of a polyphase alternating current such as a four-phase.

### (Alternation and Communication Between Master and Slave)

### <Master-Slave-Controller>

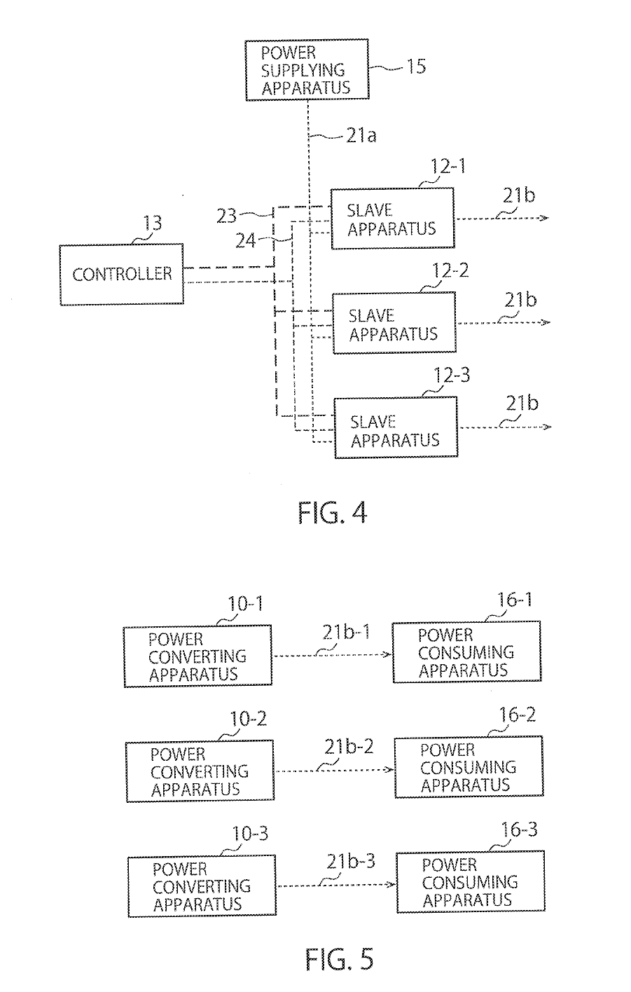

FIG. 3 and FIG. 4 show examples of the connection configurations of the power converting apparatuses according to the embodiments and the peripheral apparatuses. FIG. 3 is a first example of the connection configurations of the power converting apparatuses according to the embodiments and the peripheral apparatuses. In FIG. 3, after power activation, the functions of power converting apparatuses 10 are divided into the master and the slave. As shown in FIG. 3, of the power converting apparatuses 10, a power converting apparatus 10 to operate as the master is referred to as a master apparatus 11, and a power converting apparatus 10 to operate as the slave is referred to as a slave apparatus 12. Here, the slave apparatus 12 is a collective term of slave apparatuses 12-1, 12-2.

Then, a synchronized output is performed based on a target value to be shared by the communication using an information communication line 23 and a synchronous signal to be shared using a synchronous signal line 24. The master apparatus 11 generates the synchronous signal, and the slave apparatuses 12-1, 12-2 receive the synchronous signal. A power supplying apparatus 15, as an example, is connected with the master apparatus 11 and the slave apparatuses 12-1, 12-2 through an input power line 21a. Through this input power line 21a, the power supplying apparatus 15 supplies power to the master apparatus 11 and the slave apparatuses 12-1, 12-2.

FIG. 4 is a second example of the connection configurations of the power converting apparatuses according to the embodiments and the peripheral apparatuses.

In FIG. 4, unlike FIG. 3, a controller 13 generates the synchronous signal, and slave apparatuses 12-1, 12-2, 12-3 receive the synchronous signal. The controller 13 herein, which generates the synchronous signal although being not a power converting apparatus, is not necessarily a superordinate apparatus in communication or control. The slave apparatuses 12-1, 12-2, 12-3 convert, in the apparatuses, the power input from the power supplying apparatus 15 through the input power line 21a, and output it through an output power line (power line) 21b.

The input and the output both may be either direct current or alternating current. The number of phases may be a single phase, three phases or more phases. Hereinafter, explanations will be made assuming that the output is a single-phase or three-phase alternating current. The input voltage is supplied by the power supplying apparatus 15. Concretely, the power supplying apparatus 15 is, for example, a small or middle scale grid such as a utility grid or a micro grid, and is an apparatus such as various power generating apparatuses and various power storing apparatuses, or a combination of these multiple apparatuses. In some cases, the power conversion by a power transforming apparatus is performed on the way.

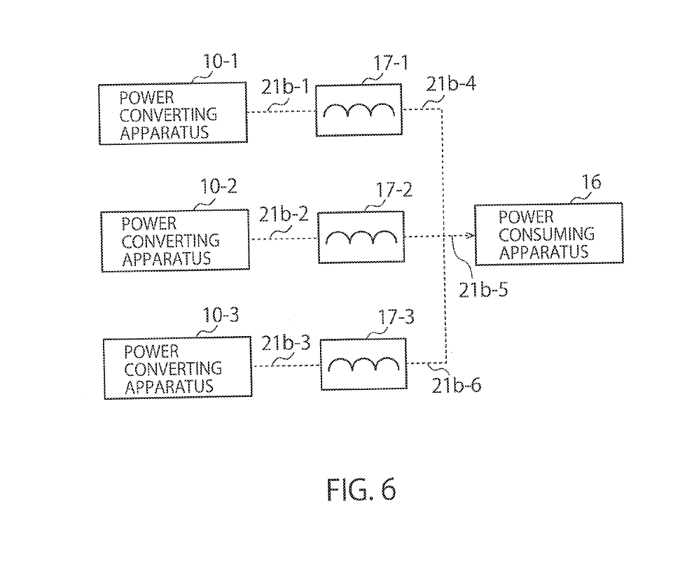

FIG. 5 and FIG. 6 illustrate manners on the output side of the power converting apparatus 10. FIG. 5 is a first example of the configuration on the output side of the power converting apparatus 10. Power converting apparatuses 10-1, 10-2, 10-3 may be either the master or the slave. The outputs of the power converting apparatuses 10-1 to 10-3 are connected with power consuming apparatuses 16-1 to 16-3 through output power lines (power lines) 21b-1 to 21b-3, respectively.

Examples of the power consuming apparatus 16 include a small or middle scale grid such as a utility grid or a micro grid, and when being connected with such a grid, the power converting apparatus 10 is called a grid interconnecting inverter. Besides this, examples of the power consuming apparatus 16 include various power storing apparatuses, apparatuses such as a load, for example, a motor, and a combination of these multiple apparatuses. In some cases, there is another power transforming apparatus on the way.

As shown in FIG. 5, in some cases, the power converting apparatuses 10 provide the outputs to the individual power consuming apparatuses 16, without combining the outputs. In some cases, the power consuming apparatus 16 is an aggregate of multiple apparatuses.

FIG. 6 is a second example of the configuration on the output side of the power converting apparatus 10.

As shown in FIG. 6, in some cases, the power converting apparatuses 10 combine the outputs and output them to the power consuming apparatus 16. The power converting apparatuses 10-1 to 10-3 are connected with corresponding reactors 17-1 to 17-3 through corresponding output power lines 21b-1 to 21b-3, respectively.

Further, the reactors 17-1 to 17-3 are connected with the power consuming apparatus 16 through corresponding output lines 21b-4 to 21b-6, respectively.

In the configuration of FIG. 6, a phase deviation of the output waveforms of the power converting apparatuses, and a switching timing deviation of the PWM (Pulse Width Modulation) control appear as a cross current, and therefore, in some cases, the reactors 17 are used for reducing the cross current. When the power converting apparatuses supply gate drive signals, the output waveforms are roughly matched, and therefore, in some cases, the reactors 17 are unnecessary.

Also, when the carrier wave and control command value to be used for the PWM control, or the feed-back value along with them are shared among the power converting apparatuses 10, the output waveforms are roughly matched, and therefore, in some cases, the reactors 17 are unnecessary. When the reactors 17 are necessary but a little inductance of the output power lines 21b makes enough, the reactors 17 are not used as actual apparatuses, in some cases.

Meanwhile, in both configurations of FIG. 5 and FIG. 6, when the shaping of the output waveforms or the noise filtering is necessary, the reactors 17 are used, and further, in some cases, capacitors are used for removing noises.

### <Master-Slave Manner and Rank-Fixed Master Alternation in Comparative Example>

In a comparative example, suppose that, when multiple power converting apparatuses (for example, inverters) operate, slaves receive a synchronous signal sent by a master and synchronize the outputs. Also, this comparative example considers, for example, a case in which the master fails and stops. The comparative example has a scheme in which ranks are previously set to the slaves in the operation start phase, and when the master fails, higher rank slaves sequentially become a new master. A method for detecting the master stop is, for example, a method in which the output of a current sensor attached to the output port of the master becomes 0 on the master stop, and the slaves detect it. By using such a scheme, it is possible to select a new master even when the master suddenly stops, and to continue the operation and the output without temporarily stopping all the power converting apparatuses (for example, inverters) in the group.

### <Negative Effect of Slave Rank Fixation in Comparative Example>

However, in the above operating method in which the ranks of the slaves are fixed, it is impossible to implement a master alternation supporting various factors that change every second after the operation start of the power converting system, for example, parameters such as a good condition or bad condition by the number of accumulated errors for each power converting apparatus (for example, an inverter) and the like, a dynamic addition of a power converting apparatus (for example, an inverter), or the like. In the case where the detection of the master stop is performed by the above technique and this triggers the master alternation, the master alternation can be performed only when the master stops.

This immobilizes the operation of the power converting system, and makes it difficult to implement a more flexible operation. For example, assuming that a high-performance power converting apparatus (for example, an inverter) is newly added in the group after the power converting system starts to operate, this power converting apparatus (for example, an inverter) is the best as the master, but it is difficult to perform such an operation.

### The Embodiments

### Introduction of Communication

For implementing a more flexible operation of the power converting system, the power converting apparatuses (for example, inverters) according to the embodiments are equipped with communicating units, and the communication among the power converting apparatuses (for example, inverters) is performed, allowing for the exchange of parameter information and the master-slave alternation.

The power converting apparatuses (for example, inverters) according to the embodiments are divided into a power converting apparatus to operate as the master and power converting apparatuses to operate as the slave. However, in the basic configuration, or in the state just after activation, the power converting apparatuses do not have differences between the master and the slave. It is assumed that the power converting apparatuses (for example, inverters) perform the communication after activation, and thereby, the division of the roles as the master and the slave is determined.

Therefore, any power converting apparatus (for example, an inverter) can become the master and the slave. This means that, even when the power converting apparatus (for example, an inverter) operating as the master stops, another power converting apparatus (for example, an inverter) succeeds the operation as the master, and thereby the power converting system can continue the operation.

However, a master-dedicated power converting apparatus (for example, an inverter), a slave-dedicated power converting apparatus (for example, an inverter), and a mixture of power converting apparatuses (for example, an inverter) having different basic configurations or performances are not excluded, and the embodiments can be applied to even such cases.

### <Algorithm for Master Selection>

As the determination criterion or algorithm for selecting the master from multiple inverters having an equivalent configuration or for ranking the slaves, a variety of examples are possible. As an example, a method of determining the rank depending on what equipment is connected with the ports of the inverter, which typically has two input-output ports of a direct current port and an alternating current port, is possible.

Representative examples of the equipment or apparatuses to be connected include another inverter, a storage battery, a power generator, a load such as a motor, a utility grid or the like, more in detail, the equipment, apparatuses and others that have been previously described as an example of the system configuration according to the embodiments. Of these apparatuses, the utility grid and the storage battery seem to have the most stable power source, and therefore, it seems that, by heightening the ranks of inverters connected with these, it is possible to lower the occurrence probability of a circumstance in which the master suddenly stops.

Conversely, a power converting apparatus (for example, an inverter) that has the alternating current port connected with a different power converting apparatus (for example, an inverter) and has the direct current port connected with a load cannot operate independently in a situation in which the different power converting apparatus (for example, an inverter) has stopped, and therefore, it seems that a low rank is appropriate.

Further, when two or more power converting apparatuses (for example, inverters) are connected with storage batteries, it is possible to perform the selection of the master and the ranking of the slaves, by the algorithm utilizing parameters such as the capacities, charge amounts, accumulated charge and discharge amounts of the connected storage batteries, parameters such as the accumulated working hours, accumulated error number, housing temperature, and free memory space of the power converting apparatus (for example, an inverter), fixed or semi-fixed numerical values such as the production number and IP address of the power converting apparatus (for example, an inverter), random numbers, or the like.

In the master selection using communication, when all the power converting apparatuses have the same master-slave selection algorithm and share the same parameters, the same result is produced no matter what power converting apparatus determines the next master. However, assuming a case in which these two conditions are not completely satisfied, by the communication among the multiple power converting apparatuses, one power converting apparatus may select, from master candidates recommended by the multiple power converting apparatuses, a power converting apparatus recommended with the greatest number as the master, by a majority rule. Further, it is allowable that the ranking of master selecting coordinators is performed in advance and the first rank coordinator selects the master.

Needless to say, the embodiments can be applied to any master selection algorithm and any slave ranking algorithm.

### <Operation Sequence 1 Stop Announcement Communication>

The power converting apparatuses (for example, inverters) according to the embodiments are equipped with the master-slave selection algorithm exemplified above, and can perform the exchange of parameter information and the master-slave alternation by communication. Here, attention is paid to a situation in which multiple power converting apparatuses (for example, inverters) coordinately operate and the master is alternated.

As an example of the operation sequence when the master stops the operation, in some cases, the power converting apparatus (for example, an inverter) operating as the master performs a communication to announce the stop of its own apparatus before the stop, and then stops. This operation sequence can be further divided into some cases, as follows.

(1-A) In the stop announcement communication, the master designates a new master from the slaves, and hereafter, the designated slave operates as the master.

(1-B) The master issues a command for selecting a new master among the slaves, and then stops. The multiple slaves having received such a command start to communicate among the slaves, and select a new master. Also, a case in which the master merely sends the stop announcement communication and the slaves are regulated so as to start the master selection operation when receiving the communication can be interpreted as falling under (1-B).

(1-C) The ranking of the slaves is previously performed by communication in an ordinary operation period, and when receiving the stop announcement communication of the master, from the operating slaves, the first rank slave becomes the next master. In any case of (1-A) to (1-C), it is preferable to exchange ACK messages to ensure a secure master alternation. When the exchange of the ACK messages is included in the sequence, it is possible to perform the master alternation with no delay, even in the case where the slave that is the next master candidate has stopped the operation without realizing.

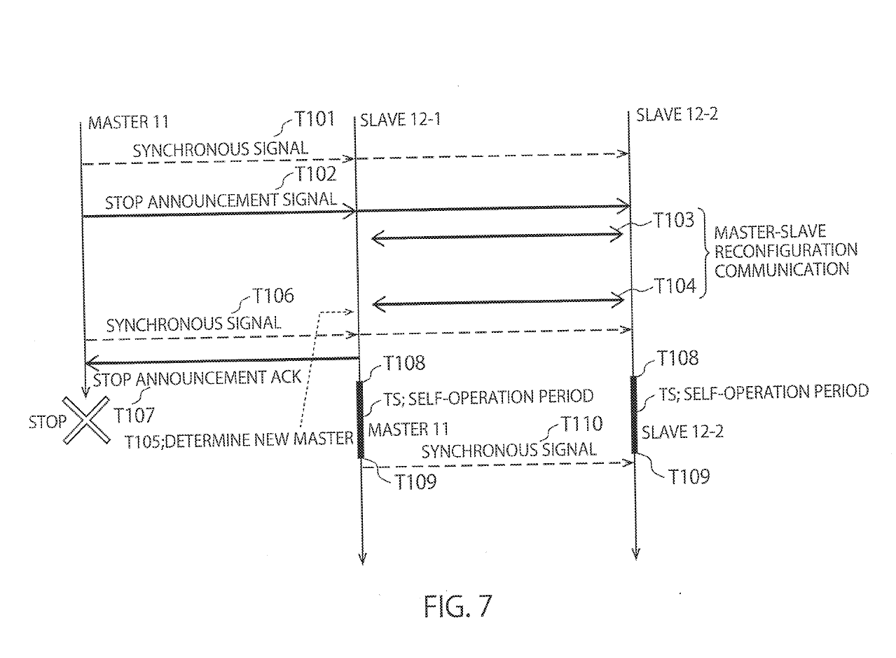

FIG. 7 illustrates the operation sequence (1-B) of the above examples. FIG. 7 is a first example of the operation sequence when, in the configuration example of FIG. 3, the master apparatus 11 stops the operation.

(T101) First, the master apparatus 11 sends the synchronous signal to the slave apparatuses 12-1, 12-2.

(T102) Next, the master apparatus 11 sends a stop announcement signal to the slave apparatuses 12-1, 12-2.

(T103) Next, the communication for reconfiguration of the master-slave is performed between the slave apparatus 12-1 and the slave apparatus 12-2.

(T104) Continuously, the communication for reconfiguration of the master-slave is performed between the slave apparatus 12-1 and the slave apparatus 12-2.

(T105) Next, the slave apparatus 12-1 determines a new master to its own slave apparatus 12-1. Thereby, the slave apparatus 12-1 becomes a new master apparatus 11.

(T106) Next, the master apparatus 11 sends the synchronous signal to the slave apparatuses 12-1, 12-2.

(T107) Next, the slave apparatus 12-1 sends a stop announcement ACK message to the master apparatus 11.

(T108) Next, the slave apparatus 12-1 and the slave apparatus 12-2 start the phase control based on the synchronous signal received at time “T106”.

(T109) When a self-operation period “TS” has lapsed since time “T108”, the slave apparatus 12-1 and the slave apparatus 12-2 finish the phase control of the output alternating current voltage based on the synchronous signal received at time “T106”.

(T110) Next, the new master apparatus 11 sends the synchronous signal to the slave apparatus 12-2.

However, the stop announcement ACK message at time “T107” is not essential, and the embodiments can be configured without this. Further, although the above (1-A) to (1-C) show an example of the procedure of the master alternation associated with the stop of the master, the stop of the master is not an essential condition, and it is possible to perform, as a part of the normal operation, the master alternation, for example, a master alternation to a slave with fewer accumulated errors.

### <Operation Sequence 2 Sudden Stop>

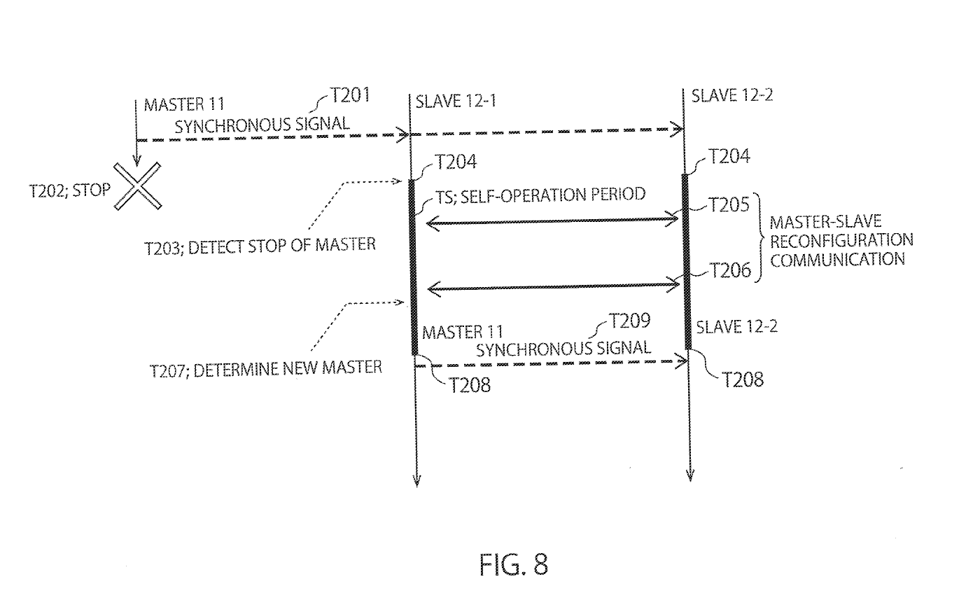

Further, as another example of the operation sequence when the master stops, it is assumed that the master suddenly stops without performing the communication before the stop. FIG. 8 illustrates the outline of the operation sequence in that case. FIG. 8 is a second example of the operation sequence when, in the configuration example of FIG. 3, the master apparatus 11 stops the operation.

(T201) First, the master apparatus 11 sends the synchronous signal to the slave apparatuses 12-1, 12-2.

(T202) Next, the master apparatus 11 suddenly stops.

(T203) Next, the slave apparatus 12-1 detects the stop of the master.

(T204) Next, the slave apparatus 12-1 and the slave apparatus 12-2 start the phase control based on the synchronous signal received at time “T201”.

(T205) Next, the communication for reconfiguration of the master-slave is performed between the slave apparatus 12-1 and the slave apparatus 12-2.

(T206) Continuously, the communication for reconfiguration of the master-slave is performed between the slave apparatus 12-1 and the slave apparatus 12-2.

(T207) Next, the slave apparatus 12-1 determines a new master to its own slave apparatus 12-1. Thereby, the slave apparatus 12-1 becomes a new master apparatus 11.

(T208) When a self-operation period “TS” has lapsed since time “T204”, the slave apparatus 12-1 and the slave apparatus 12-2 finish the phase control based on the synchronous signal received at time “T201”.

(T209) Next, the new master apparatus 11 sends the synchronous signal to the slave apparatus 12-2.

In this example, a main assumed case is a case in which, due to the failure of the master apparatus 11, the master apparatus 11 stops without performing the communication in advance. However, it is allowable to be a case in which, as a part of the normal operation procedure, the operation is stopped without the stop announcement by communication. When the master apparatus 11 stops, the operating slave apparatuses 12-1, 12-2 detect the stop of the master apparatus 11 and execute the selection process of a controlling apparatus to operate as a new master.

The selection process of the master may be any of the following.

(2-A) The multiple apparatuses perform the communication, and select the controlling apparatus to operate as a new master, from the slaves.

(2-B) The ranks of the slaves are previously set in a normal operation period before the master stops, and when the master stops, the controlling apparatus to operate as a new master is selected based on the ranks. For a smooth transfer of the master, it is essential that the other slaves recognize that the first rank slave is surely operating. Therefore, the first rank slave performs a communication for declaring the master alternation, before or after the promotion to the master. In the normal operation procedure, the other slaves receive the message regarding the master alternation from the first rank slave, in a certain period since the recognition of the stop of the master, and confirm the master alternation. When the above message cannot be received in the certain period, the second rank slave is promoted to the master, on the assumption that not only the stopped master but also the first rank slave has stopped the operation. Whether the second or lower rank slave has been properly promoted to the master can be confirmed using the same technique as the procedure relevant to the promotion of the first rank slave.

### <Example of Communication Content>

The content of the communication to be performed by the power converting apparatuses according to the embodiments is, for example, as follows. First, the communication content regarding the reconfiguration of the master-slave includes the following examples.

(1) Communication regarding the designation of the next master, particularly when the current master designates the next master.

(2) Communication regarding the selection of the next master.

(3) Communication regarding the ranking of all the apparatuses or the slaves.

(4) Communication regarding the working statuses of the next master candidate or all the apparatuses. Communication exchanging parameters such as types of the apparatuses connected with power converting apparatuses, the hardware specs, the housing temperature, and the number of accumulated errors.

Besides the above, the following communications of contents regarding the work and stop of the apparatuses are performed.

(5) Communication for informing the other apparatuses in the periphery about the work of its own apparatus, particularly at the time of activation. It may be performed any time at work.

(6) Communication for informing the other apparatuses in the periphery about the failure and stop expectation of its own apparatus.

(7) Communication for confirming the information regarding the work, failure and stop of another apparatus, to the apparatus in question.

(8) Communication for informing the other apparatuses in the periphery about the information regarding the work, failure and stop of another apparatus.

Further, (9) the communication corresponding to ACKs for the above communications may be performed. The multiple power converting apparatuses are operated by one or a combination of the above multiple communications. Needless to say, the embodiments can be applied, even when a communication of a content other than the above is performed.

A power converting apparatus to function only as the master or a power converting apparatus to function only as the slave can be added to the systems configured by the power converting apparatuses according to the embodiments. For example, the controller 13 that does not have an AC/DC converting function but includes hardware or a program to perform the sending and receiving of the synchronous signal can be incorporated in the system, as a kind of power converting apparatus.

For enhancing the redundancy of the system, two or more controllers 13 described above can be incorporated in the system. Also, an inverter that does not have a communication function and a sending function of the synchronous signal, and the like can be incorporated in the system, as a slave-dedicated power converting apparatus. When the master stops and only one power converting apparatus remains and is working, the remaining one operates as the master or in a mode of operating independently.

On this occasion, it is appropriate to stop the sending of the synchronous signal through the signal line, because of no slave. Further, for example, when the master suddenly stops, it is allowable to perform an error check of whether there is a power converting apparatus that has stopped, besides, or whether there is a power converting apparatus that has not stopped but has made an error or a partial failure.

### (Synchronous Signal Disruption Measure)

### <Problem of Synchronous Signal Disruption in Master Alternation Period>

In the power converting apparatuses (for example, inverters) according to the embodiments, the synchronous signal generated by the master, which is one of the multiple power converting apparatuses (for example, inverters), is received by the slaves, which are the remaining power converting apparatuses (for example, inverters), and the synchronization is performed. When the master stops, a new master is selected by the communication among the slaves, and the new master starts to generate the synchronous signal.

Now, in the power converting apparatuses (for example, inverters) according to the embodiments that perform the master alternation using communication as described above, in a case such as (1-A) in which the master designates the next master before the stop, the number of times of the communication regarding the master alternation is reduced, and it can be performed in a relatively short period. However, in a case such as (2-A) or (2-B) that is triggered by an unpredicted stop of the master, the number of times of the communication regarding the master alternation is increased, and it takes a certain period to complete it. In both cases, since the communication is used, there is a probability of an occurrence of a packet missing and a re-sending associated with this. Further, since the master to send the synchronous signal is absent until the communication is completed, there is a fear that the synchronization cannot be kept.

### <Solution by Combined Use of PLL Self-Operation and Communication>

Here, in the embodiments, the power converting apparatus (for example, an inverter) to operate as the slave includes a phase synchronization circuit unit. Then, the slave temporarily inputs the synchronous signal to a PLL (Phase Locked Loop) for holding the synchronous timing. Therewith, when the synchronous signal is disrupted, the slave maintains, for a short period, the output synchronization among the multiple power converting apparatuses (for example, inverters), by utilizing the self-operation of the PLL, and meanwhile, completes the communication regarding the master alternation. Then, the new master starts to send the synchronous signal. By using the above scheme, it is possible to avoid the problem in that, while the communication regarding the master alternation is performed, the synchronous signal is disrupted and the synchronization is disordered.

### First Embodiment

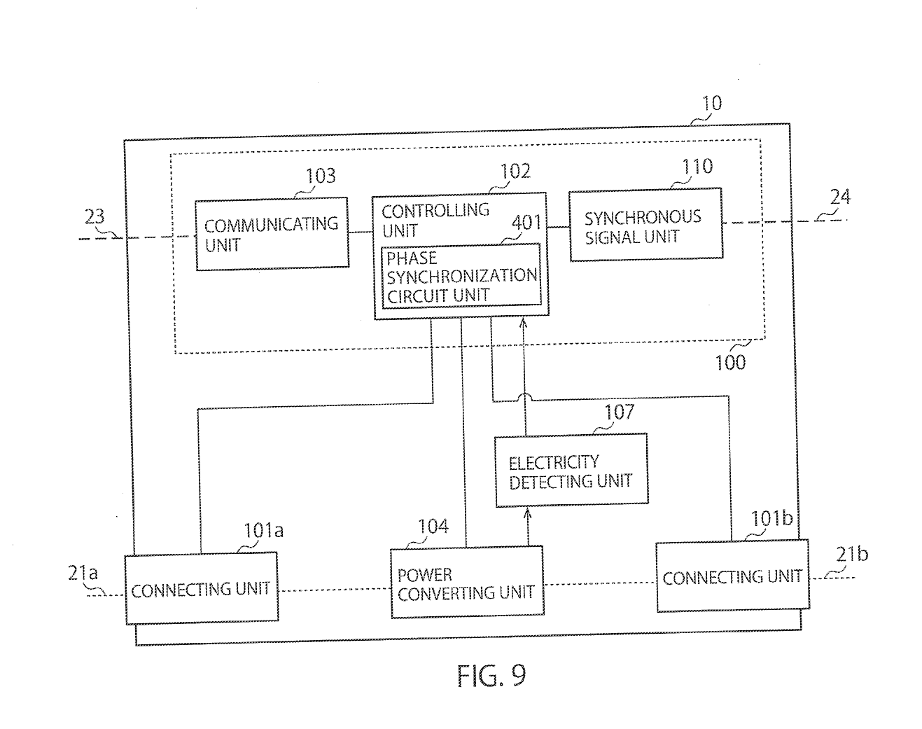

Next, a power converting apparatus 10 according to a first embodiment, which implements the above functions and application uses, will be explained. FIG. 9 is a schematic block diagram showing the configuration of the power converting apparatus 10 according to the first embodiment.

The power converting apparatus 10 includes a connecting unit 101a to be connected with the input power line 21a, and a connecting unit 101b to be connected with the output power line 21b.

Furthermore, the power converting apparatus 10 includes a power converting unit 104 connected with the connecting unit 101a and the connecting unit 101b through a power line, and an electricity detecting unit 107 electrically connected with the power converting unit 104.

Furthermore, the power converting apparatus 10 includes a controlling apparatus 100 that is connected with the connecting unit 101a, the connecting unit 101b and the power converting unit 104 through a communication line and controls them.

The connecting unit 101a outputs the power input through the input power line 21a from the power supplying apparatus 15 not shown in the figure, to the power converting unit 104.

The power converting unit 104 converts the power input through the connecting unit 101a, and outputs the converted power to the output power line (power line) 21b through the connecting unit 101b.

The connecting unit 101b outputs the power output by the power converting unit 104, to the output power line (power line) 21b. Thereby, this power is transmitted to the power consuming apparatuses 16 or 16-1 to 16-3 not shown in the figure.

The electricity detecting unit 107 detects an electric signal (here, a voltage “Vfb”, as an example) after the conversion by the power converting unit 104, and outputs the detected electric signal to a controlling unit 102, described later, of the controlling apparatus 100.

The controlling apparatus 100 controls the power converting apparatus 10 that converts the power and outputs the converted power to the output power line (power line) 21b. Here, the controlling apparatus 100 includes a communicating unit 103 that communicates with the other power converting apparatuses, the controller 13, and other communicating apparatuses.

Furthermore, the controlling apparatus 100 includes a synchronous signal unit 110 that is electrically connected with the synchronous signal line 24, and through this synchronous signal line 24, performs the sending and receiving of the synchronous signal with the other power converting apparatuses and the controller 13.

Furthermore, the controlling apparatus 100 includes the controlling unit 102 that is connected with the communicating unit 103, the power converting unit 104 and the synchronous signal unit 110 through the communication line, and controls the whole. Here, the controlling unit 102 includes a phase synchronization circuit unit 401.

Any of the input power line 21a and the output power line 21b may be an input power line or an output power line, and a third or higher power lines and connecting units may be present. The information communication line 23 and the synchronous signal line 24 do not need to be physical wires, and may be transmitting means such as wireless.

Thus, the communicating unit 103 communicates with at least one other controlling apparatus.

Then, for example, the communicating unit 103 acquires, from the at least one other controlling apparatus, at least one of the information regarding the other controlling apparatus, the information regarding the power converting apparatus to control the other controlling apparatus and the information regarding apparatuses electrically connected with the power converting apparatus, as the information for determining the master, by communication. The information regarding the apparatuses electrically connected with the power converting apparatus is, for example, parameters such as the capacity, charge amount and accumulated charge and discharge amount of a connected storage battery, or the like.

The information regarding the other controlling apparatus described above is, for example, the information regarding the property of the other controlling apparatus (for example, the operating frequency of the CPU, the memory capacity or the like), the information regarding the current and/or past state of the other controlling apparatus, or the information specific to the controlling apparatus (for example, the IP address and MAC address of the communicating unit 103). Here, the information regarding the current and/or past state of the other controlling apparatus is, for example, parameters such as the accumulated working hours, accumulated error number, housing temperature, and free memory space of the other controlling apparatus, or the like.

The information regarding the power converting apparatus described above is, for example, the information regarding the current and/or past state of the power converting apparatus 10, the information specific to the power converting apparatus 10, or the information regarding the wire connection among the power converting apparatuses 10. Here, the information regarding the current and/or past state of the power converting apparatus 10 is, for example, parameters such as the accumulated working hours, accumulated error number, housing temperature, and free memory space of the power converting apparatus 10, or the like. The information specific to the power converting apparatus 10 is, for example, the production number of the power converting apparatus 10 or the IP address of the communicating unit 103.

Further, a synchronous signal unit 110 receives the synchronous signal that is the basis of the phase of the output power by the power converting apparatus 10, from a controlling apparatus to operate as the master that outputs the synchronous signal.

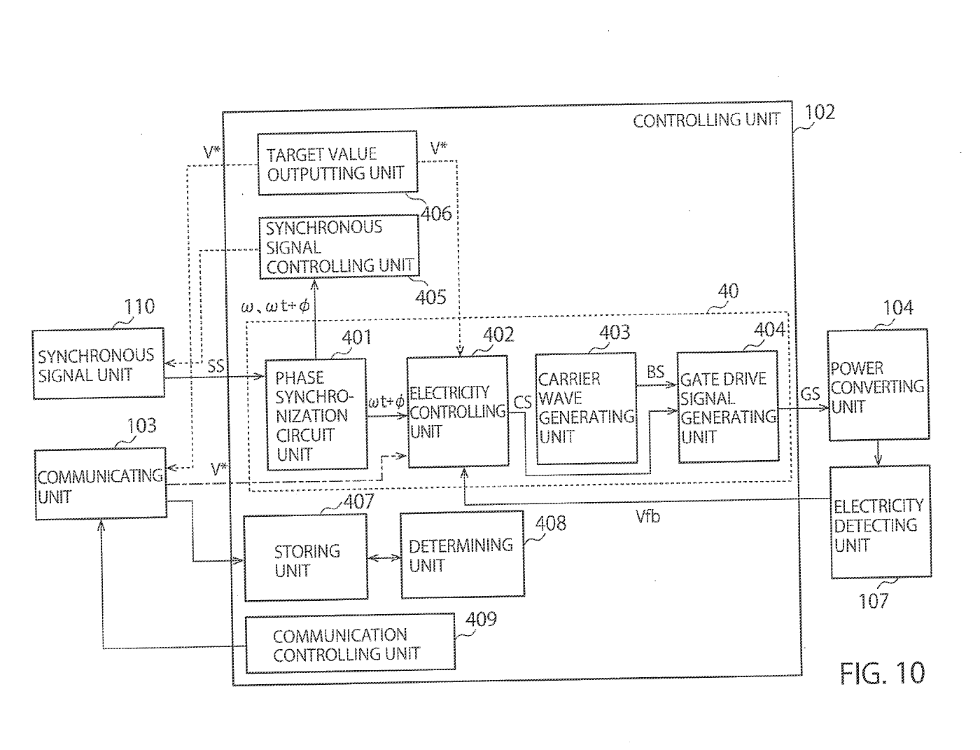

FIG. 10 is a schematic block diagram showing the configuration of the controlling unit 102 according to the first embodiment. In the figure, the solid line denotes the wire connection to be used in common by the master and the slave. The broken line denotes the wire connection to be used when operating as the master. The alternate long and short dash line denotes the wire connection to be used when operating as the slave.

The input synchronous signal to be input from the synchronous signal unit 110 contains the information of an angular frequency “ω” and a phase difference “φ”. To this, a feed-forward value “ω₀” of the angular frequency and the change information are obtained by the communication through the communicating unit 103, leading to the improvement of the convergence speed and stabilization of the control to be performed in the phase synchronization circuit unit 401, and leading to the maintenance of the synchronization that takes into account the velocity change when the synchronous signal is disrupted. In addition, by the communication, a target value (for example, a voltage command, a torque designation or the like) is received and is used for the control in an electricity controlling unit 402.

Here, the sensing information from various other sensors may be fed back and used for the control in the electricity controlling unit 402. The sensors may be incorporated in the power converting apparatus 10, or the sensing information by external sensors may be acquired from the communicating unit 103 using communication.

The controlling unit 102 includes a power phase controlling unit 40 that is electrically connected with the synchronous signal unit 110, the communicating unit 103, the power converting unit 104 and the electricity detecting unit 107.

Furthermore, the controlling unit 102 includes a synchronous signal controlling unit 405 that has the input electrically connected with the output of the phase synchronization circuit unit 401 and has the output electrically connected with the synchronous signal unit 110.

Furthermore, the controlling unit 102 includes a target value outputting unit 406 that has the output electrically connected with the electricity controlling unit 402 and the synchronous signal unit 110.

Furthermore, the controlling unit 102 includes a storing unit 407 that has the input electrically connected with a second output of the communicating unit 103.

Furthermore, the controlling unit 102 includes a determining unit 408 that is electrically connected with the storing unit 407.

Furthermore, the controlling unit 102 includes a communication controlling unit 409 that controls the communicating unit 103.

In the storing unit 407, the information for determining the master that the communicating unit 103 acquires from the other controlling apparatus by communication is stored.

The communication controlling unit 409 controls the communicating unit 103 such that, for the information for determining the master among the controlling apparatuses other than the controlling apparatus to operate as the master, the communicating unit 103 performs either one of the receiving from the controlling apparatuses of the other power converting apparatuses and the sending to the controlling apparatuses of the other power converting apparatuses, while the power phase controlling unit 40 performs the control based on the synchronous signal received before the disruption.

When the communicating unit 103 receives the information for determining the master among the controlling apparatuses of the other power converting apparatuses, the controlling unit 102 stores the information for determining the master, in the storing unit 407.

While the power phase controlling unit 40 performs the control based on the synchronous signal before the disruption, the determining unit 408 determines the controlling apparatus to operate as a new master, based on the information for determining the master that the communicating unit 103 has received from the controlling apparatuses of the other power converting apparatuses. More in detail, for example, when the synchronous signal unit 110 cannot receive the synchronous signal, the determining unit 408 compares the information for determining the master that the communicating unit 103 has acquired, among the controlling apparatuses, and determines the master based on the comparison result.

Concretely, for example, since the information for determining the master that the communicating unit 103 has acquired is stored in the storing unit 407, the determining unit 408 compares the information for determining the master that is stored in the storing unit 407, among the controlling apparatuses, and determines the master based on the comparison result.

The power phase controlling unit 40 controls the phase of the power to be output to the output power line (power line) 21b by the power converting apparatus, based on the synchronous signal received by the synchronous signal unit 110.

Further, when the disruption of the synchronous signal is detected, the power phase controlling unit 40 controls the phase of the power to be output to the output power line (power line) 21b by the power converting apparatus 10, based on the synchronous signal received before the disruption.

Here, the power phase controlling unit 40 includes the phase synchronization circuit unit 401, and the electricity controlling unit 402 that has a first input electrically connected with the output of the phase synchronization circuit unit 401, has a second input electrically connected with the first output of the communicating unit 103, and has a third input electrically connected with the output of the electricity detecting unit 107.

Furthermore, the power phase controlling unit 40 includes a carrier wave generating unit 403, and a gate drive signal generating unit 404 that has a first input electrically connected with the output of the electricity controlling unit 402 and has a second input electrically connected with the output of the carrier wave generating unit 403.

The phase synchronization circuit unit 401 acquires a synchronous signal “SS” from the synchronous signal unit 110, and determines the angular frequency “ω” and the phase “ωt+φ”, based on the acquired synchronous signal “SS”. Then, the phase synchronization circuit unit 401 outputs the determined phase “ωt+φ” to the electricity controlling unit 402, and outputs the determined angular frequency “ω” and the phase “ωt+φ” to the synchronous signal controlling unit 405.

In the above described self-operation “TS”, the phase synchronization circuit unit 401 performs such a control that the difference between the phase of the synchronous signal received before the disruption and the phase to be output is reduced. Thereby, the power phase controlling unit 40 controls the phase of the power to be output by the power converting unit 104 of the power converting apparatus 10, based on the phase output by the phase synchronization circuit unit 401.

The electricity controlling unit 402 acquires the phase “ωt+φ)”, a target value (for example, a targeted output voltage) “V*”, and the electric signal detected by the electricity detecting unit 107. Then, the electricity controlling unit 402 generates a command value “CS”, in response to the acquired phase “ωt+φ” and target value “V*”, and the electric signal (here, the voltage “Vfb”, as an example) detected by the electricity detecting unit 107. Here, the command value “CS” is time-series data for determining a duty ratio of a gate drive signal described later.

Concretely, for example, the electricity controlling unit 402 applies the phase “ωt+φ”, the target value “V*” and the voltage “Vfb”, to a previously determined transfer function “F”, and thereby, generates the command value “CS”. The transfer function “F” is determined such that the magnitude of the command value “CS” becomes larger as the target value “V*” becomes larger relative to the voltage “Vfb”, and the magnitude of the command value “CS” becomes smaller as the target value “V*” becomes smaller relative to the voltage “Vfb”.

Thereby, it is possible to bring the voltage after the conversion by the power converting unit 104, close to the target value “V*”.

The electricity controlling unit 402 outputs the command value “CS” to the gate drive signal generating unit 404.

The carrier wave generating unit 403 generates a carrier signal “BS” that is, for example, a periodic signal (for example, a sine wave signal) with a predetermined frequency (for example, 10 KHz), and outputs the generated carrier signal “BS” to the gate drive signal generating unit 404.

The gate drive signal generating unit 404 compares the command value “CS” generated by the electricity controlling unit 402 and the carrier signal “BS” generated by the carrier wave generating unit 403, and generates the gate drive signal based on the comparison result. Concretely, for example, the gate drive signal generating unit 404 generates a gate drive signal that is at a high-level during the time when the command value “CS” is equal to or greater than the amplitude of the carrier signal “BS”, and is at a low-level during the time when the command value “CS” is less than the amplitude of the carrier signal “BS”. The gate drive signal generating unit 404 outputs the generated gate drive signal to the power converting unit 104.

Thereby, a switching element of the power converting unit 104 is driven. Concretely, the power converting unit 104 generates, for example, a pulse signal that is at a high-level when the gate drive signal is at the high-level, and is at a low-level when it is at the low-level. Then, for example, the power converting unit 104 removes high frequency noises from the pulse signal while shaping the pulse signal into a sine wave, and outputs the sine wave signal after the shaping, to the power consuming apparatus 16.

<Process when Operating as Master>

When the controlling apparatus 100 in question is a controlling apparatus that the determining unit 408 has determined as the master, the synchronous signal unit 110 sends the synchronous signal to the other controlling apparatuses. On this occasion, when the controlling apparatus 100 in question is a controlling apparatus that the determining unit 408 has determined as the master, the synchronous signal controlling unit 405 makes the synchronous signal unit 110 send the synchronous signal to the other controlling apparatuses. More in detail, the synchronous signal controlling unit 405 controls the synchronous signal unit 110, based on the angular frequency “ω” and the phase “ωtφφ” input by the phase synchronization circuit unit 401. Thereby, the synchronous signal unit 110 outputs the synchronous signal having the angular frequency “ω” and the phase “ωt+φ”, to the other controlling apparatuses.

As an example, when operating as the master, the target value outputting unit 406 outputs the target value (here, a targeted output voltage, as an example) “V*”, which is the targeted output value of the power converting apparatus 10, to the electricity controlling unit 402 and the communicating unit 103. Here, the target value “V*” may be determined by a command for the target value from a grid, or may be previously determined.

Then, the communicating unit 103 sends the target value “V*” to the other controlling apparatuses. Thereby, the communicating unit 103 of the controlling apparatus 100 to operate as the slave receives the target value “V*”, and the electricity controlling unit 402 of the controlling apparatus 100 to operate as the slave can acquire the target value “V*”.

The electricity controlling unit 402 of the controlling apparatus 100 to operate as the master acquires the target value (for example, a targeted output voltage) “V*” output by the target value outputting unit 406.

Here, when the power converting apparatus is connected with a grid, the target voltage to be output by each power converting apparatus 10 is previously determined as a predetermined voltage (for example, 200 V). Therefore, the electricity controlling unit 402, which previously stores the predetermined voltage (for example, 200V), may use this stored predetermined voltage (for example, 200 V) as the target value “V*”.

Furthermore, each power converting apparatus 10 may further include a mode switching unit to switch the mode in response to the designation of an operator that operates the power converting apparatus. Then, when the operator designates a grid connection mode in which the power converting apparatus 10 is connected with a grid, and the mode switching unit switches the mode to the grid connection mode, the electricity controlling unit 402 may use the stored predetermined voltage (for example, 200 V) as the target value “V*”.

Further, instead of the controlling apparatus to operate as the master, the controller 13 may send the target value “V*” to each controlling apparatus.

<Process when Operating as Slave>

When the controlling apparatus 100 in question operates as the slave apparatus that receives the synchronous signal, the synchronous signal unit 110 receives the synchronous signal “SS” sent by the master. In that case, the power phase controlling unit 40 controls the phase of the power to be output by the power converting unit 104 of the power converting apparatus 10, based on the synchronous signal “SS” received by the synchronous signal unit 110.

The communicating unit 103 receives the target value “V*” sent by the master, and outputs the received target value “V*” to the electricity controlling unit 402. Thereby, the electricity controlling unit 402 acquires the target value “V*” output by the communicating unit 103.

Here, the signal and information flow shown in FIG. 10 is just one example, and in some cases, a synchronous signal is used for synchronizing the carrier wave among the multiple power converting apparatuses. In this case, the carrier wave generating unit 403 can include a PLL in the interior, and the same technique as a process to be performed for a modulation wave can be applied. In this case, two kinds of signal lines may be used, or the superimposition of two kinds of signals is possible. The communicating means of the communicating unit 103 may be any communicating means such as wire communication, wireless communication, optical communication and others, and they can be adopted as the communicating means of the present invention, regardless of the standard and protocol.

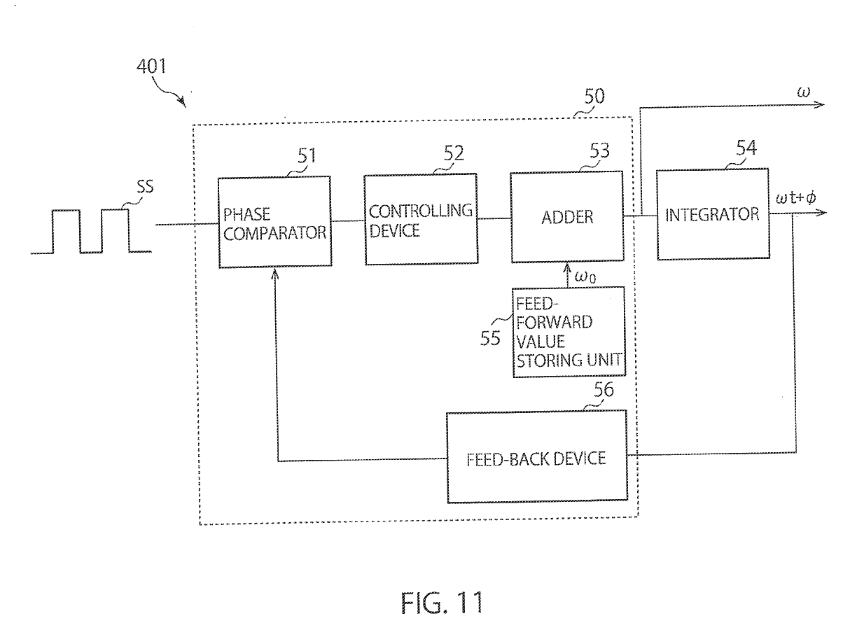

FIG. 11 is a schematic block diagram showing the configuration of the phase synchronization circuit unit 401 according to the first embodiment. FIG. 11 illustrates an ADPLL (All Digital Phase Locked Loop, All Digital PLL), as an example of the phase synchronization circuit unit 401.

The phase synchronization circuit unit 401 includes an angular frequency detecting unit 50 and an integrator (integrating unit) 54. The angular frequency detecting unit 50 detects the information regarding the angular frequency, based on the synchronous signal and the phase to be output by the integrator 54. Here, the angular frequency detecting unit 50 includes a phase comparator 51 to which the synchronous signal “SS” is input from the first input, a controlling device 52 that has the input electrically connected with the output of the phase comparator 51, and an adder 53 that has the first input electrically connected with the output of the controlling device 52.

Furthermore, the angular frequency detecting unit 50 includes a feed-forward value storing unit 55 that has the output electrically connected with the second input of the adder 53, and a feed-back device 56 that has the input electrically connected with the output of the integrator 54 and has the output electrically connected with the second input of the phase comparator 51.

The integrator 54 has the input electrically connected with the output of the adder 53.

The phase comparator 51, based on the input synchronous signal, calculates the time difference of the rising or trailing to the feed-back device 56, and outputs the calculated time difference to the controlling device 52.

The controlling device 52 performs the stable convergence of the timing held by the phase synchronization circuit unit 401, using a control technique such as a PI control, for example. Concretely, for example, the controlling device 52 performs the Laplace transform of the input time difference, and multiplies the transformed value by a predetermined transfer function “G(s)”. Here, “s” is a complex number. Further, the predetermined transfer function “G(s)” is represented by “G(s)=(1/(1+sT_{Control}))”, for example. Here, “T_{Control}” is a time constant representing the time spent on the convergence or divergence, and when this “T” is small, the above time difference early becomes small and early converges.

For example, the controlling device 52 performs the inverse Laplace transform of the value resulting from the multiplication by the transfer function “G(s)”, and outputs the value resulting from performing it (the adjustment amount of the angular frequency), to the adder 53.

In the feed-forward value storing unit 55, a feed-forward value is stored, and the adder 53 acquires the feed-forward value from the feed-forward value storing unit 55. By the feed-forward value, the feed-back control is quickly stabilized. For example, when the inverter is interconnected with a grid of 50 Hz, the adder 53 adds a feed-forward value of 50*2π, and thereby, the phase and angular frequency held by the phase synchronization circuit unit 401 are more quickly converged from the initial state to a stable state.

Here, the adder 53 and the feed-forward value storing unit 55 are not essential constituent elements, and the use of 0 as the feed-forward value results in an equivalence to a controlling system without the adder 53 and the feed-forward value storing unit 55.

The adder 53 adds the value input from the controlling device 52 and the feed-forward value, and obtains the angular frequency “ω”. The adder 53 outputs the angular frequency “ω” to the integrator 54 and the synchronous signal controlling unit 405 not shown in the figure.

The integrator 54 integrates the angular frequency “ω” obtained by the adder 53, to generate the phase “ωt+φ”, and outputs the phase “ωt+φ” to the feed-back device 56, and the synchronous signal controlling unit 405 and electricity controlling unit 402 not shown in the figure.

When the synchronous signal input to the phase comparator 51 has a pulse waveform, for example, the feed-back device 56 uses, as a rectangular wave function, a function “f” whose argument is the phase “ωt+φ” generated by the integrator 54, and generates a pulse signal by the function “f”. Then, for example, the feed-back device 56 outputs the generated pulse signal to the phase comparator 51. Thereby, the phase comparator 51 can determine the time difference of the raising or trailing between the synchronous signal and the pulse signal.

Further, for example, the feed-back device 56 may divide the phase “ωt+φ”, which is the output of the integrator 54, into the angular frequency “ω” and the phase difference “φ”, and may output them to the phase comparator 51. In that case, the phase comparator 51 may define the rising of the input synchronous signal as a phase of 0, and may output the difference (hereinafter, referred to as the angular frequency difference) between the angular frequency “ω_{IN}” of the input synchronous signal and the angular frequency “ω” obtained from the feed-back device 56, and the phase difference “φ” obtained from the feed-back device 56, to the controlling device 52. In that case, the controlling device 52 may perform the PI control for the angular frequency difference and may perform the PI control for the phase difference “φ”.

To be configured in such a way is an effective method in the case where the angular frequency “ω_{IN}” of the synchronous signal is stable, particularly, in the case of a grid interconnection, or the like. Further, the path of the feed-back is not limited to the figure, and the power converting apparatus 10 (for example, an inverter), which shapes the waveform of the output voltage using the output of the phase synchronization circuit unit 401, may be configured such that the measured value of the output voltage with a voltmeter is output to the input of the feed-back device 56.

A frequency divider or an integrator can be used as the feed-back device 56, and besides this, the frequency divider or the integrator can be incorporated in an arbitrary controlling block within the phase synchronization circuit unit 401.

The configuration using the feed-back allows for a control that takes into account the delay and disturbance of the output, also. However, the feed-back device 56 and the feed-back control are not essential elements for the phase synchronization circuit unit 401, and the embodiment can adopt an open loop for the phase synchronization circuit unit 401.

The above is just one example of the phase synchronization circuit unit 401, and the present invention can be applied even when using an ADPLL that has a different configuration from the above, or a PLL that is partially or wholly configured by analogue components, unless departing from the spirit of the embodiment. The phase synchronization circuit unit 401 may incorporate therein, for example, a VCO (Voltage Controlled Oscillator), a frequency divider, an adder, an integrator, a low pass filter, a band pass filter or the like.

### <General Controlling System: Stability and Response Speed>

Generally, in a system in which a feed-back control is performed, for a disturbance of the input or a sudden change in the value (for example, the disruption of the input signal), the controlling system has a certain level of robustness and stability. In many cases, the degree of the stability has a trade-off relation with the response speed of the controlling system, and therefore, in the case of requiring a more quick response, it is necessary to abandon the securing of the stability to some extent. Conversely, in a use in which a quick response speed is not required, it is desirable to set a high stability for the controlling system. In a grid interconnection inverter, when the grid is normal, it is quite unlikely that the frequency of the grid greatly departs from a fixed value of 50 Hz or 60 Hz, and it is likely that the frequency of the grid is relatively stable. Therefore, the stability of the phase synchronization circuit unit 401 can be highly set.

### <Self-Operation of Phase Synchronization Circuit Unit 401>

Now, suppose that, in the case where an inverter using the above phase synchronization circuit unit 401 operates as the slave, the input of the synchronous signal from the master is disrupted. Even when the input signal is disrupted, the phase synchronization circuit unit 401 having a relatively high stability can continue holding the timing stably for a while, and can continue the output synchronized among multiple inverters. Meanwhile, the power converting apparatus (for example, an inverter) 10 that has detected the disruption of the synchronous signal starts to communicate, and determines a controlling apparatus to operate as a new master.

The controlling apparatus 100 determined as the new master continues the output based on the phase synchronization circuit unit 401 of its own apparatus, and therewith, starts to send the synchronous signal to the other slaves. The other slaves, to which the resumed synchronous signal is input, correct the timings held in the phase synchronization circuit units 401, each of which has been a little deviated while the synchronous signal is disrupted.

To take as an example the phase synchronization circuit unit 401 that performs the PI control in the controlling device 52, in this controlling system, the control diverges in the order of the time constant “T_{Control}”. Therefore, a period “T_{MasterChange}” required from the stop of the master to the selection of the new master is previously measured, and a parameter for the control is set such that “T_{Control}” is sufficiently longer than “T_{MasterChange}”. Thereby, it is possible to securely change the master before the phase synchronization circuit unit 401 diverges, and therefore, it is possible to implement the functions according to the embodiment.

### Effect of First Embodiment

In the power converting apparatus 10 according to the first embodiment, when the master (the power converting apparatus that generates the synchronous signal) stops, the multiple slaves (the apparatuses that receive the synchronous signal and thereby perform the output synchronized with the master) communicate with each other, and thereby, it is possible to select the optimal slave as a new master. Therewith, the phase synchronization circuit unit 401 maintains the phase, and thereby, the power converting apparatus 10 can continue outputting the alternating current voltage, without disordering the synchronization of the phase even while the selection of the master is performed by communication. Furthermore, since the synchronous signal unit 110 always monitors the synchronous signal, it is possible to quickly detect the stop of the master, and even when the master fails, the power converting apparatus 10 can perform the continuous operation by smoothly alternating the master. Therefore, in the power converting apparatus 10 according to the first embodiment, the power converting system has flexibility, and can maintain the continuous operation of the power converting system even when the controlling apparatus to operate as the master stops unpredictably.

### Second Embodiment

Next, a second embodiment will be explained. In the second embodiment, a phase synchronization circuit unit having a different configuration from the phase synchronization circuit unit according to the first embodiment will be explained. The phase synchronization circuit unit according to the second embodiment further has a function to detect the presence or absence of the synchronous signal, and a function to switch the control depending on the presence or absence thereof.

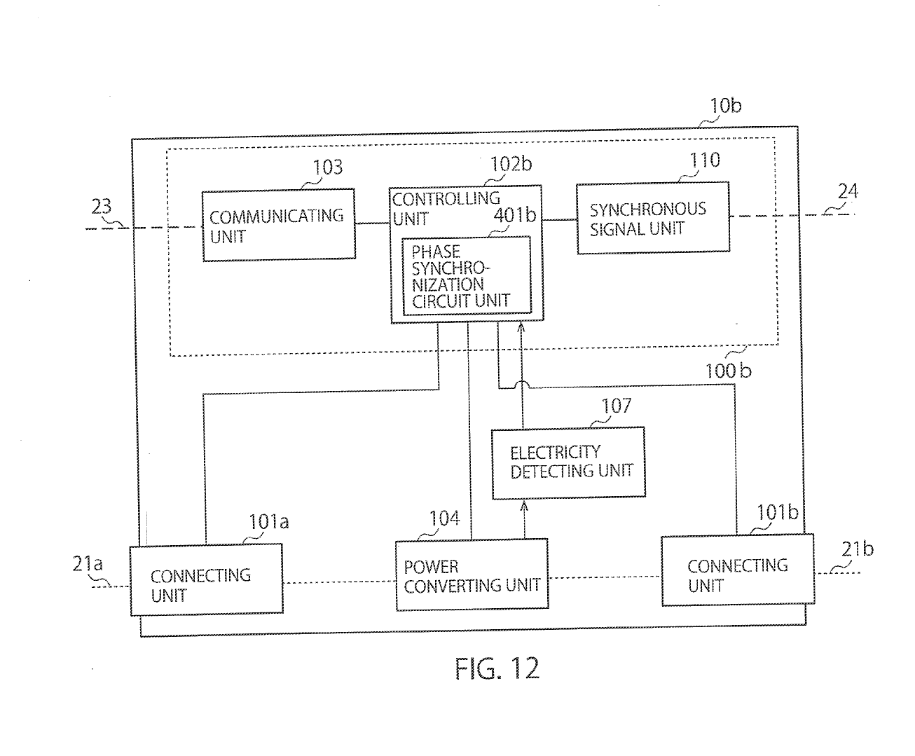

FIG. 12 is a schematic block diagram showing the configuration of a power converting apparatus 10b according to the second embodiment. Here, the same reference characters are assigned to elements in common with FIG. 9, and the concrete explanations are omitted.

Compared to the configuration of the power converting apparatus 10 according to the first embodiment, in the configuration of the power converting apparatus 10b according to the second embodiment, the phase synchronization circuit unit 401 is changed into a phase synchronization circuit unit 401b. Because of this, the controlling unit 102 is changed into a controlling unit 102b, and the controlling apparatus 100 is changed into a controlling apparatus 100b.

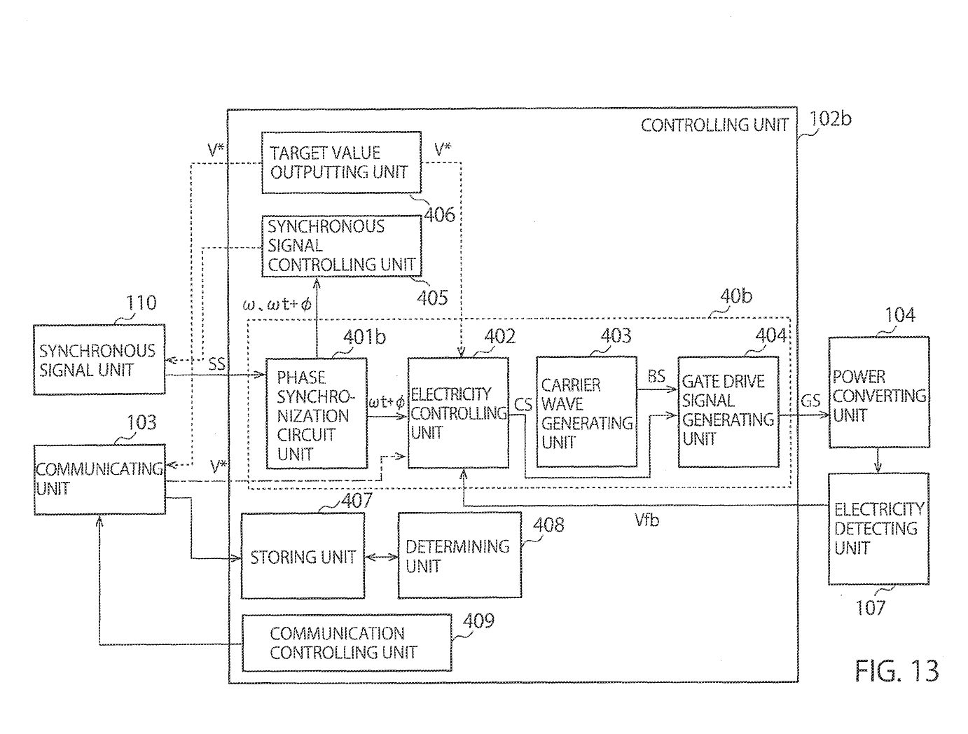

FIG. 13 is a schematic block diagram showing the configuration of the controlling unit 102b according to the second embodiment. Here, the same reference characters are assigned to elements in common with FIG. 10, and the concrete explanations are omitted. Compared to the configuration of the controlling unit 102 according to the first embodiment, in the configuration of the controlling unit 102b according to the second embodiment, the phase synchronization circuit unit 401 is changed into the phase synchronization circuit unit 401b, and because of this, the power phase controlling unit 40 is changed into a power phase controlling unit 40b.

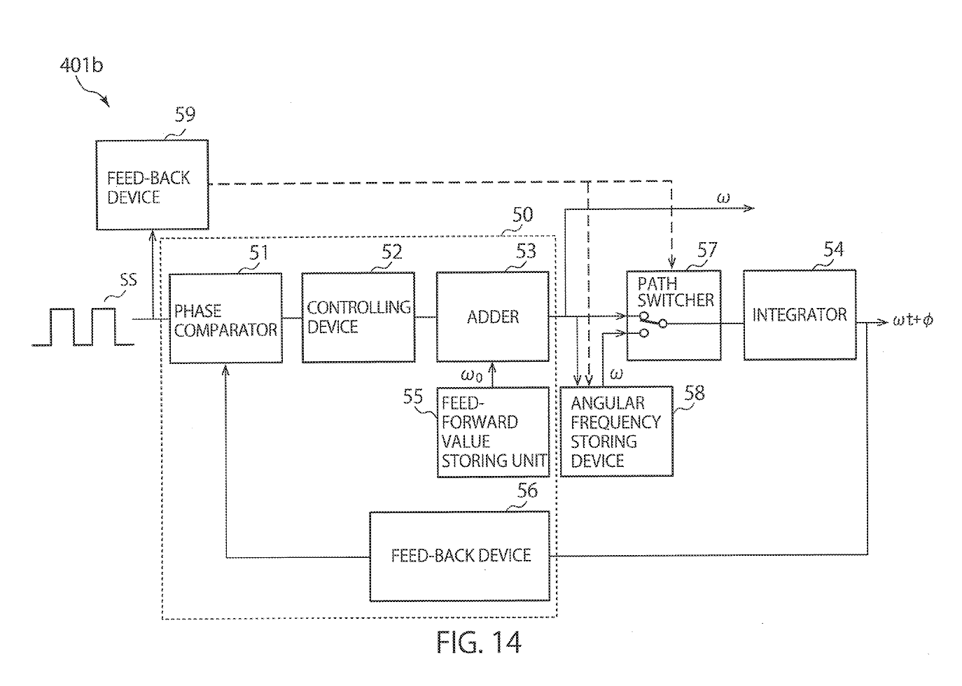

FIG. 14 is a schematic block diagram showing the configuration of the phase synchronization circuit unit 401b according to the second embodiment. Here, the same reference characters are assigned to elements in common with FIG. 11, and the concrete explanations are omitted. Compared to the configuration of the phase synchronization circuit unit 401 according to the first embodiment, in the configuration of the phase synchronization circuit unit 401b according to the second embodiment, a path switcher 57, an angular frequency storing device (angular frequency storing unit) 58, and a signal detector (signal detecting unit) 59 to which the synchronous signal is input are further added.

The phase synchronization circuit unit 401b further has a function to detect the presence or absence of the synchronous signal, and a function to switch the control depending on the presence or absence thereof.

The path switcher 57 has a first input port electrically connected with the output of the adder 53, has a second input port electrically connected with the angular frequency storing device 58, and has the output port electrically connected with the input of the integrator 54. Based on a control signal to be input from the signal detector 59, the path switcher 57 switches between a state in which the first input port is conductive with the output port and a state in which the second input port is conductive with the output port.

While the signal detector 59 detects that the synchronous signal is not disrupted, the angular frequency storing device 58 updates the stored information regarding the angular frequency, with the information regarding the angular frequency that is generated by the angular frequency detecting unit 50. More in detail, while the signal detector 59 detects that the synchronous signal is input, the angular frequency storing device 58, for example, updates the stored angular frequency “ω”, with the angular frequency “ω” output by the adder 53. On the other hand, when the signal detector 59 detects the disruption of the synchronous signal, the angular frequency storing device stops the update of the angular frequency “ω”, and outputs the angular frequency “ω” to the integrator 54, in response to the control signal of the signal detector 59.

The signal detector 59 always monitors the presence or absence of the synchronous signal. In other words, the signal detector 59 detects whether or not the synchronous signal is disrupted. Then, when the synchronous signal is being input, by the signal detector 59, the control path managed by the path switcher 57 becomes equivalent to the control path of FIG. 11 in the first embodiment.

When the disruption of the synchronous signal is detected, the signal detector 59 switches the control path managed by the path switcher 57, so that a state in which the input of the integrator 54 is conductive with the output of the adder 53 is switched to a state in which the input of the integrator 54 is conductive with the output of the angular frequency storing device 58. Therewith, the signal detector 59 makes the angular frequency storing device 58 stop the update of the angular frequency “ω” and output the angular frequency “ω” to the path switcher 57. Thereby, the angular frequency “ω” output by the angular frequency storing device 58 is input to the integrator 54.

### Effect of Second Embodiment

Thus, in the phase synchronization circuit unit 401b according to the second embodiment, the angular frequency detecting unit 50 detects the information regarding the angular frequency, based on the synchronous signal. The signal detector 59 detects whether or not the synchronous signal is disrupted. While the signal detector 59 detects that the synchronous signal is not disrupted, the angular frequency storing device 58 updates the stored information regarding the angular frequency, with the information regarding the angular frequency that is detected by the angular frequency detecting unit 50. When the signal detector 59 detects the disruption of the synchronous signal, the integrator 54 acquires the information regarding the angular frequency, from the angular frequency storing device 58, and generates the phase based on the acquired information regarding the angular frequency. The power phase controlling unit 40 controls the phase of the power to be output by the above power converting apparatus 10b, based on the phase generated by the integrator 54.

The phase synchronization circuit unit 401b according to the second embodiment explained above, while the synchronous signal is not input, outputs the phase using the angular frequency “ω” output by the adder 53 immediately after the disruption of the synchronous signal, and therefore, can maintain the phase more exactly than the phase synchronization circuit unit 401 according to the first embodiment.

Therefore, in addition to the effects of the first embodiment, in the second embodiment, even when a relatively short time constant “T_{Control}” is set for the controlling device 52, it is possible to continue maintaining the synchronization for a while after the synchronous signal from the master is disrupted. Then, the power converting apparatus 10b, meanwhile, selects a new master using communication, and thereby, it is possible to implement a continuous output as the power converting system.

### Third Embodiment

Next, a third embodiment will be explained. In the third embodiment, a phase synchronization circuit unit having a different configuration from the phase synchronization circuit units according to the first embodiment and the second embodiment will be explained.

The third embodiment is mainly intended to be applied to a power converting apparatus in which the output frequency is changed. The representative example is a power converting apparatus for a motor drive. Since the target rotation frequency and displacement angle of a motor are quite often changed, the output frequency of the power converting apparatus that is a driving apparatus is also changed at all times.

When the output frequency is quite often changed, it is difficult to effectively utilize the feed-forward, and therefore, in some cases, a controlling system that does not use the feed-back value is adopted. In the case where the master stops and the synchronous signal is disrupted when the motor is accelerating or decelerating, the synchronization among the multiple inverters can be maintained even when using the phase synchronization circuit units according to the first embodiment and the second embodiment.

However, in the phase synchronization circuit units according to the first embodiment and the second embodiment, the acceleration cannot be held, and therefore, the acceleration before the synchronous signal disruption, which results from the second order differential of the output frequency with respect to time, is drastically lost. Assuming that the inverter is used for a motor drive and an elevator or a railway vehicle is driven, the drastic change in the acceleration results in an impairment of a comfortable ride quality for passengers, and therefore, it is undesirable.

Hence, a phase synchronization circuit unit 401c according to the third embodiment, when the synchronous signal from the master is disrupted, updates the information regarding the angular frequency (here, the angular frequency “ω”, as an example) that is stored in the angular frequency storing device 58, using velocity change information such as the acceleration that is the first order differential of the angular frequency “ω”.

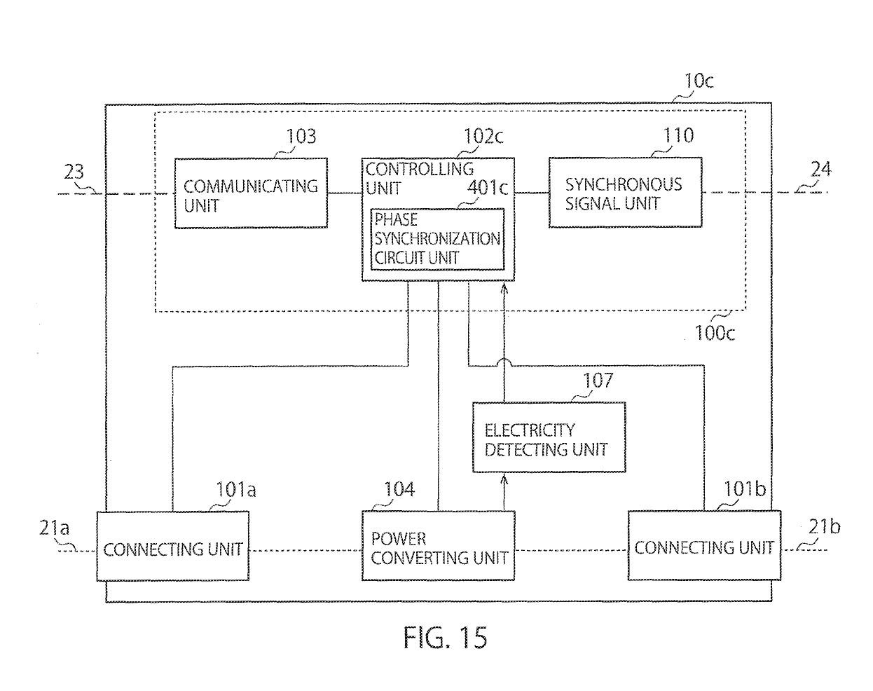

FIG. 15 is a schematic block diagram showing the configuration of the power converting apparatus 10c according to the third embodiment. Here, the same reference characters are assigned to elements in common with FIG. 9, and the concrete explanations are omitted.

Compared to the configuration of the power converting apparatus 10 according to the first embodiment, in the configuration of the power converting apparatus 10c according to the third embodiment, the phase synchronization circuit unit 401 is changed into a phase synchronization circuit unit 401c. Because of this, the controlling unit 102 is changed into a controlling unit 102c, and the controlling apparatus 100 is changed into a controlling apparatus 100c.

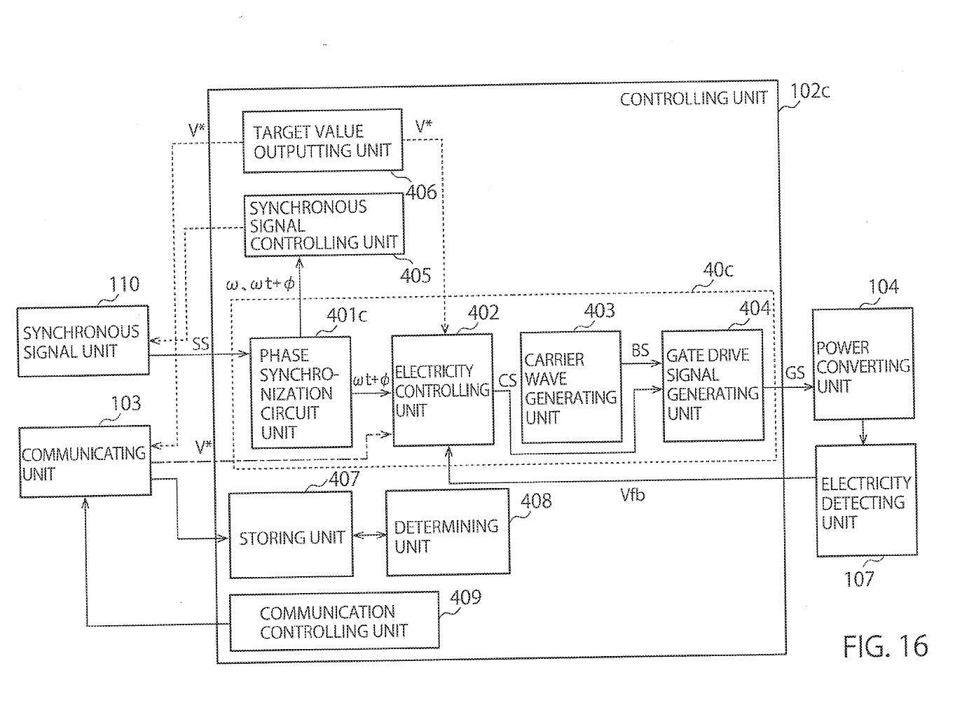

FIG. 16 is a schematic block diagram showing the configuration of the controlling unit 102c according to the third embodiment. Here, the same reference characters are assigned to elements in common with FIG. 10, and the concrete explanations are omitted. Compared to the configuration of the controlling unit 102 according to the first embodiment, in the configuration of the controlling unit 102c according to the third embodiment, the phase synchronization circuit unit 401 is changed into the phase synchronization circuit unit 401c, and because of this, the power phase controlling unit 40 is changed into a power phase controlling unit 40c.

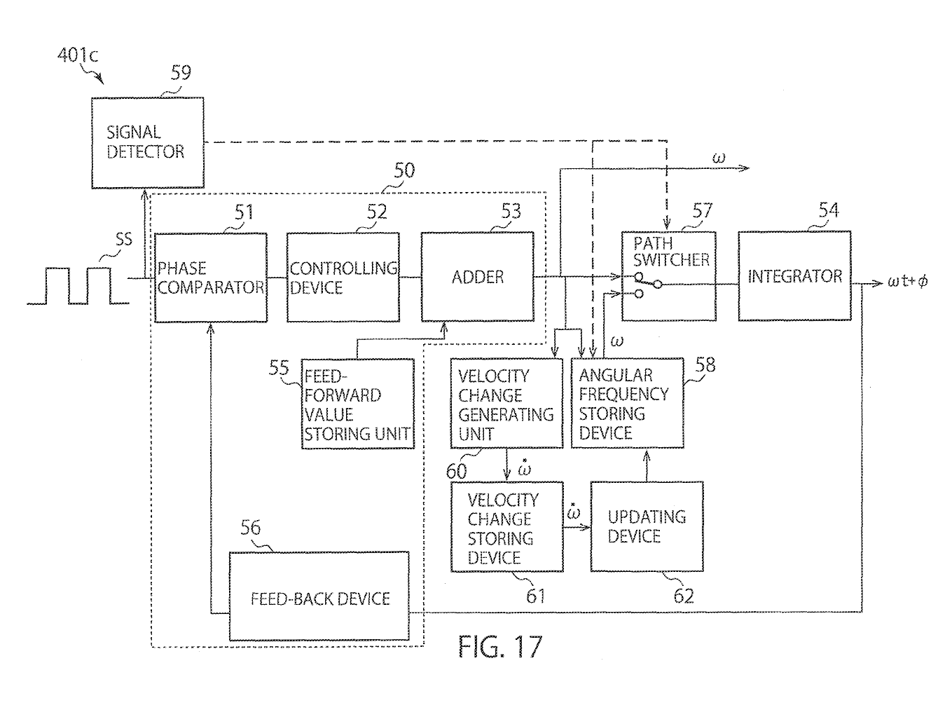

FIG. 17 is a schematic block diagram showing the configuration of the phase synchronization circuit unit 401c according to the third embodiment. Here, the same reference characters are assigned to elements in common with FIG. 14, and the concrete explanations are omitted. Compared to the configuration of the phase synchronization circuit unit 401b according to the second embodiment, in the configuration of the phase synchronization circuit unit 401c according to the third embodiment, a velocity change generating unit 60, a velocity change storing device (velocity change storing unit) 61 and an updating device (updating unit) 62 are further added.

The velocity change generating unit 60 has the input electrically connected with the output of the adder 53. The velocity change storing device 61 has the input electrically connected with the output of the velocity change generating unit 60. The updating device 62 has the input electrically connected with the output of the velocity change storing device 61, and has the output electrically connected with the angular frequency storing device 58.

The velocity change generating unit 60 generates the velocity change information regarding the temporal change in the angular frequency generated by the angular frequency detecting unit 50. More in detail, when the power converting apparatus to operate as the slave normally operates, that is, when it receives the synchronous signal from the master, the velocity change generating unit 60, for example, always performs the first order and/or second or more order differentials of the angular frequency “ω” output by the adder, and thereby, generates the velocity change information such as the acceleration and/or the acceleration jerk (lurch, jerk). Here, the acceleration is the first order differential of the angular frequency “ω” with respect to time, and the acceleration jerk is the second order differential of the angular frequency “ω” with respect with time.

While the signal detector 59 detects that the synchronous signal is not disrupted, the velocity change storing device 61 updates the stored velocity change information with the velocity change information generated by the velocity change generating unit 60.

When the synchronous signal from the master is disrupted, the phase synchronization circuit unit 401c switches to a self-operation using the angular frequency storing device 58. On this occasion, when the signal detector 59 detects the disruption of the synchronous signal, the updating device 62 starts to update the angular frequency stored in the angular frequency storing device 58, based on the velocity change information stored in the velocity change storing device 61.

Concretely, for example, the updating device 62 updates the angular frequency “ω_{NEW}” after the update, by “ω_{NEW}=ω+(dω/dt)t”. Here, “t” is a time, and “(dω/dt)” is an acceleration.

Here, the updating device 62 may further calculate the acceleration jerk “(d²ω/dt²)”, and may update the angular frequency “ω_{NEW}” after the update, by “ω_{NEW}=ω+(dω/dt)t+(d²ω/dt²)t²”.

### Effect of Third Embodiment

Thus, in the third embodiment, the velocity change generating unit 60 generates the velocity change information regarding the temporal change in the angular frequency generated by the angular frequency detecting unit 50. Then, while the signal detector 59 detects that the synchronous signal is not disrupted, the velocity change storing device 61 updates the stored velocity change information with the velocity change information generated by the velocity change generating unit 60. When the signal detector 59 detects the disruption of the synchronous signal, the updating device 62 starts to update the information regarding the angular frequency that is stored in the angular frequency storing device 58, with the velocity change information stored in the velocity change storing device 61.

Therefore, in addition to the effects of the first embodiment, in the power converting apparatus 10c according to the third embodiment, by using such a scheme of the phase synchronization circuit unit 401c, the power converting apparatus 10c can implement an alternating current voltage output in which the influence of the synchronous signal disruption associated with the stop of the master and the acceleration change in connection with this is minimized. In the above way, the self-operation of the phase synchronization circuit unit 401c is performed with the acceleration kept. Thereby, it is possible to maintain the synchronization, to perform the master alternation using communication, and to resume the sending of the synchronous signal before the synchronization is disordered.

Here, the updating device 62 may estimate a future change in the angular frequency “ω” from the angular frequency “ω”, the differential value and the like, using a further advanced algorithm, and may update the feed-forward value based on the estimation. For example, the updating device 62 may estimate a future change in the angular frequency “ω” from a history of differential values of past angular frequencies “ω”. Also, the updating device 62 may estimate a future change in the angular frequency “ω” from the statistical information of temporal changes in past angular frequencies “ω”.

Here, the application example in the embodiment is not necessarily limited to a motor drive.

### Fourth Embodiment

Next, a fourth embodiment will be explained. Unlike the third embodiment, in the fourth embodiment, the frequency information is acquired using communication, and is used in a phase synchronization circuit unit.

Similarly to the third embodiment, the fourth embodiment is mainly intended that the invention is applied to an inverter in which the output frequency is changed. The representative example is an inverter for a motor drive. Similarly to the above other embodiments, a power converting apparatus according to the fourth embodiment includes a phase synchronization circuit unit to which the synchronous signal such as a pulse waveform is input.

As the input to the power converting apparatus according to the fourth embodiment, besides the synchronous signal, the feed-forward value “ω₀” of the angular frequency “ω” are acquired by communication and are used. While the synchronous signal can be normally received, the feed-forward value “ω₀” is updated at all times using communication.

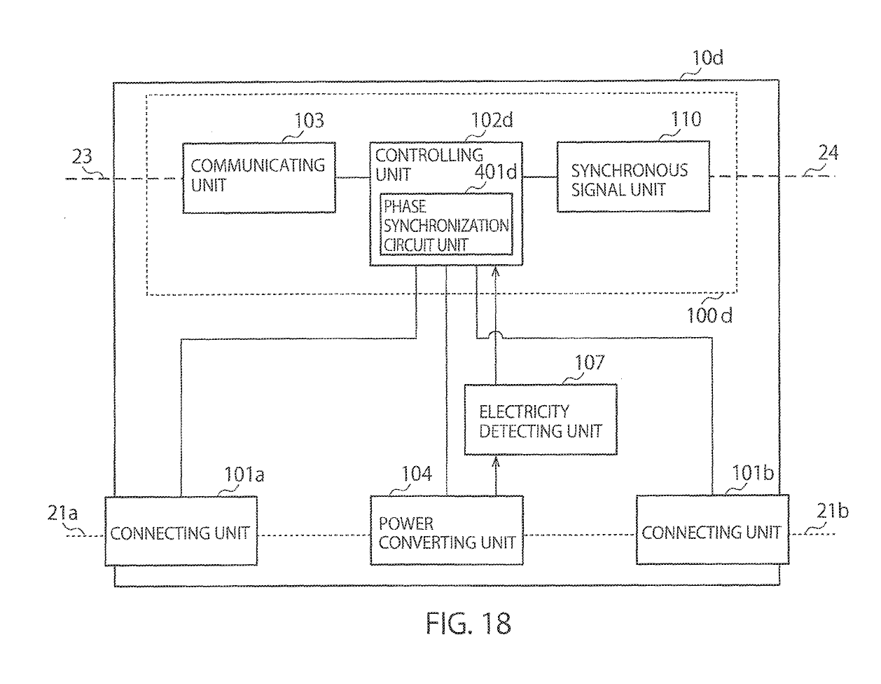

FIG. 18 is a schematic block diagram showing the configuration of a power converting apparatus 10d according to the fourth embodiment. Here, the same reference characters are assigned to elements in common with FIG. 9, and the concrete explanations are omitted.

Compared to the configuration of the power converting apparatus 10 according to the first embodiment, in the configuration of the power converting apparatus 10d according to the fourth embodiment, the phase synchronization circuit unit 401 is changed into a phase synchronization circuit unit 401d. Because of this, the controlling unit 102 is changed into a controlling unit 102d, and the controlling apparatus 100 is changed into a controlling apparatus 100d.

Assuming that the power converting apparatus according to the fourth embodiment is applied to a railway vehicle or an elevator, the output velocity of the motor and the output frequency of the power converting apparatus that is proportional to it are quite often updated in such a use, but the changing manner can be estimated to some extent in advance. For example, a railway vehicle typically continues accelerating for a certain period after departure, and with respect to the future within several seconds, the schedule and estimation of the acceleration can be made. By giving such estimated information from a superordinate such as the master or a controller to the inverter, it is possible to implement the phase synchronization circuit unit 401d that, at the ordinary time, promptly follows a change in the velocity of the railway vehicle or the output frequency of the power converting apparatus.

As an example, it is assumed that a feed-forward value “ω₀” (=2πf) that is calculated from the estimation of the output frequency “f” of the power converting apparatus is stored in the master or the controller.

In addition to the function of the communicating unit 103 according to the first embodiment, a communicating unit 103 acquires, at multiple times, the frequency information regarding the frequency of the power to be output by the power converting apparatus 10d, by the communication with the master, the controller or the like. In the embodiment, the frequency information is the feed-forward value “ω₀” of the angular frequency “ω”.

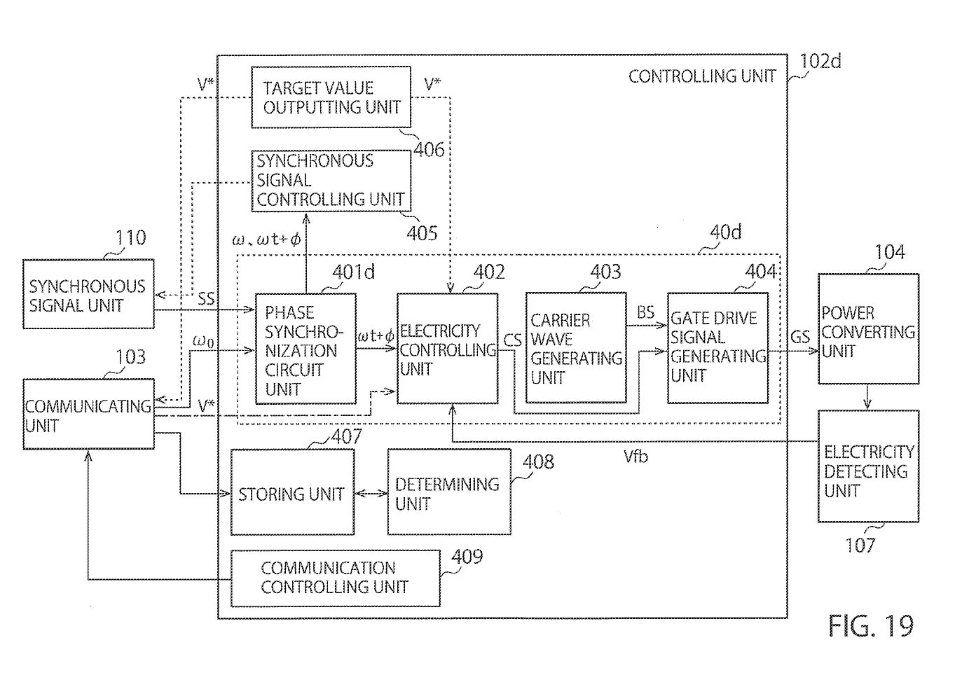

FIG. 19 is a schematic block diagram showing the configuration of the controlling unit 102d according to the fourth embodiment. Here, the same reference characters are assigned to elements in common with FIG. 10, and the concrete explanations are omitted. Compared to the configuration of the controlling unit 102 according to the first embodiment, in the configuration of the controlling unit 102d according to the fourth embodiment, the phase synchronization circuit unit 401 is changed into the phase synchronization circuit unit 401d, and because of this, the power phase controlling unit 40 is changed into a power phase controlling unit 40d.

Unlike the phase synchronization circuit unit 401, the phase synchronization circuit unit 401d is further electrically connected with the communicating unit 103, and acquires the feed-forward value “ω₀”.

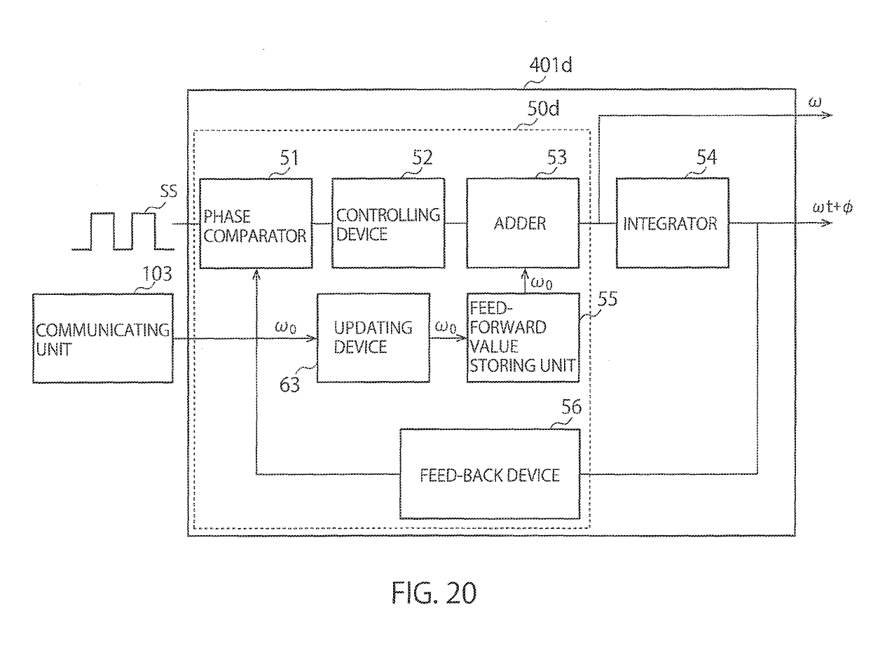

FIG. 20 is a schematic block diagram showing the configuration of the phase synchronization circuit unit 401d according to the fourth embodiment. Here, the same reference characters are assigned to elements in common with FIG. 11, and the concrete explanations are omitted. Compared to the configuration of the phase synchronization circuit unit 401 according to the first embodiment, in the configuration of the phase synchronization circuit unit 401d according to the fourth embodiment, an updating device (updating unit) 63 is added, and because of this, the angular frequency detecting unit 50 is changed into an angular frequency detecting unit 50d.

The angular frequency detecting unit 50d generates the information regarding the angular frequency, based on the synchronous signal and the frequency information acquired by the communicating unit 103. Thereby, the integrator 54 generates the phase, based on the information regarding the angular frequency that is generated by the angular frequency detecting unit 50d.

The updating device 63 acquires the feed-forward value “ω₀” from the communicating unit 103, and updates the feed-forward value stored in the feed-forward value storing unit 55, with the acquired feed-forward value “ω₀”.

Here, the updating device 63 may output the data (for example, the angular frequency or the differential value) received from the communicating unit 103, with no change. Further, the updating device 63 may perform the integral of the received data (for example, the differential value of the angular frequency), or the like, to output it. Further, the updating device 63 may perform a control such as a PI control, for the data received from the communicating unit 103, and may output the control result. When the updating device 63 itself has a controlling system in this way, it is possible to perform such an update that the feed-forward value stored in the feed-forward value storing unit 55 smoothly changes with time.

Further, the update of the feed-forward value “ω₀” may be performed only when the synchronous signal is disrupted, or may be performed as a part of the ordinary control.

Here, for example, the feed-forward value “ω₀” may be given as a function of time instead of a constant. For example, the feed-forward value “ω₀” may be in a form of a schedule table for the duration of accelerating and decelerating or the change in velocity that is scheduled in the future.

### Effect of Fourth Embodiment

Thus, in the fourth embodiment, the communicating unit 103 acquires, at multiple times, the frequency information regarding the frequency of the power to be output by the power converting apparatus, by communication. The angular frequency detecting unit 50d generates the information regarding the angular frequency, based on the synchronous signal and the frequency information acquired by the communicating unit 103. Then, the integrator 54 generates the phase, based on the information regarding the angular frequency that is generated by the angular frequency detecting unit 50d.

Thereby, at the ordinary time when the synchronous signal is input, the phase synchronization circuit unit 401d outputs the angular frequency “ω”, in response to the feed-forward value “ω₀” that is updated at all times by the acquisition by the communicating unit 103. Therefore, in the power converting apparatus 10d, it is possible to implement the phase synchronization circuit unit 401d that, at the ordinary time, promptly follows a change in the output frequency of the power converting apparatus.

Here, the synchronous signal such as a pulse wave, which is input to the phase synchronization circuit unit 401d, concurrently contains the frequency information and the phase information. When normally receiving the synchronous signal, the power converting apparatus 10d, for the changing input synchronous signal, separately acquires the frequency information by communication, and adds it to the phase synchronization circuit unit 401d, as the feed-forward value “ω₀”. Thereby, it is possible to further specialize the action of the phase synchronization circuit unit 401d, in the phase synchronization for the input signal. This makes it possible to speed up the response to the frequency change in the input synchronous signal, to prevent an unnecessary overshoot and the like, and to complete the phase synchronization earlier.

### Fifth Embodiment

Next, a fifth embodiment will be explained. In addition to the fourth embodiment, a controlling apparatus according to the fifth embodiment acquires also the velocity change information using communication, and uses the acquired velocity change information in a phase synchronization circuit unit. Compared to the third embodiment, the velocity change information to be used at the time of the synchronous signal disruption is not acquired by means of differential, and the velocity change information is directly acquired by the communication with the master, the controller or the like.

Similarly to the third and fourth embodiments, the fifth embodiment is mainly intended that the invention is applied to an inverter in which the output frequency is changed. The representative example is an inverter for a motor drive.

Similarly to the above other embodiments, a power converting apparatus according to the fifth embodiment includes a phase synchronization circuit unit to which the synchronous signal such as a pulse waveform is input.

For example, a railway vehicle typically continues accelerating for a certain period after departure, and with respect to the future within several seconds, the schedule and estimation of the acceleration can be made. The power converting apparatus according to the fifth embodiment acquires the velocity change information and frequency information, which are examples of such estimated information, from the master, the controller or the like, by communication.

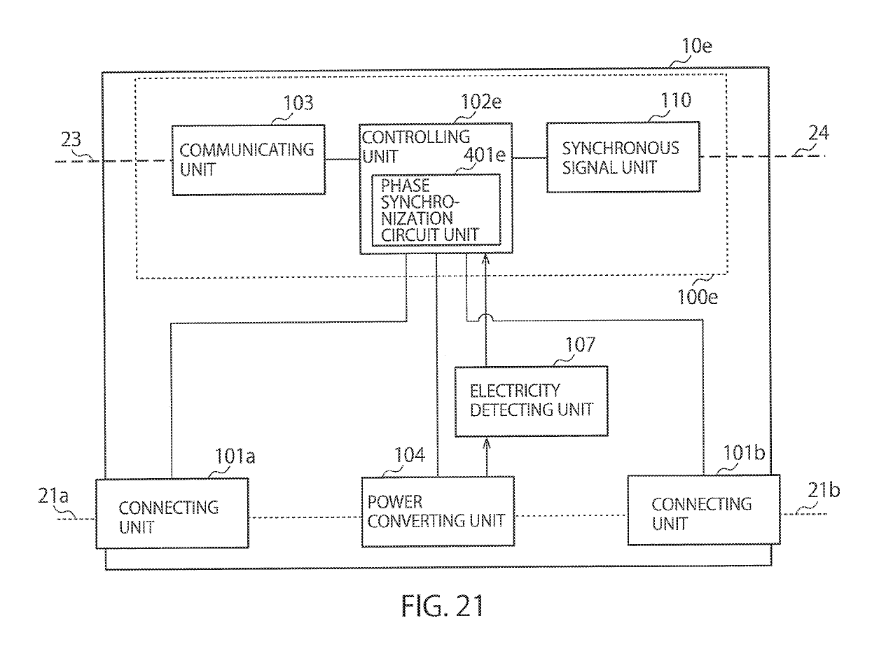

FIG. 21 is a schematic block diagram showing the configuration of a power converting apparatus 10e according to the fifth embodiment. Here, the same reference characters are assigned to elements in common with FIG. 9, and the concrete explanations are omitted.

Compared to the configuration of the power converting apparatus 10 according to the first embodiment, in the configuration of the power converting apparatus 10e according to the fifth embodiment, the phase synchronization circuit unit 401 is changed into a phase synchronization circuit unit 401e. Because of this, the controlling unit 102 is changed into a controlling unit 102e, and the controlling apparatus 100 is changed into a controlling apparatus 100e.

In addition to the function of the communicating unit 103 according to the first embodiment, a communicating unit 103 acquires the velocity change information (for example, the time-differential value of the feed-forward value “ω₀”) from the master or the controller, by communication.

Further, the communicating unit 103 acquires, at multiple times, the frequency information regarding the frequency of the power to be output by the power converting apparatus, from the master or the controller, by communication. In the embodiment, the frequency information is the feed-forward value “ω₀” of the angular frequency “ω”.

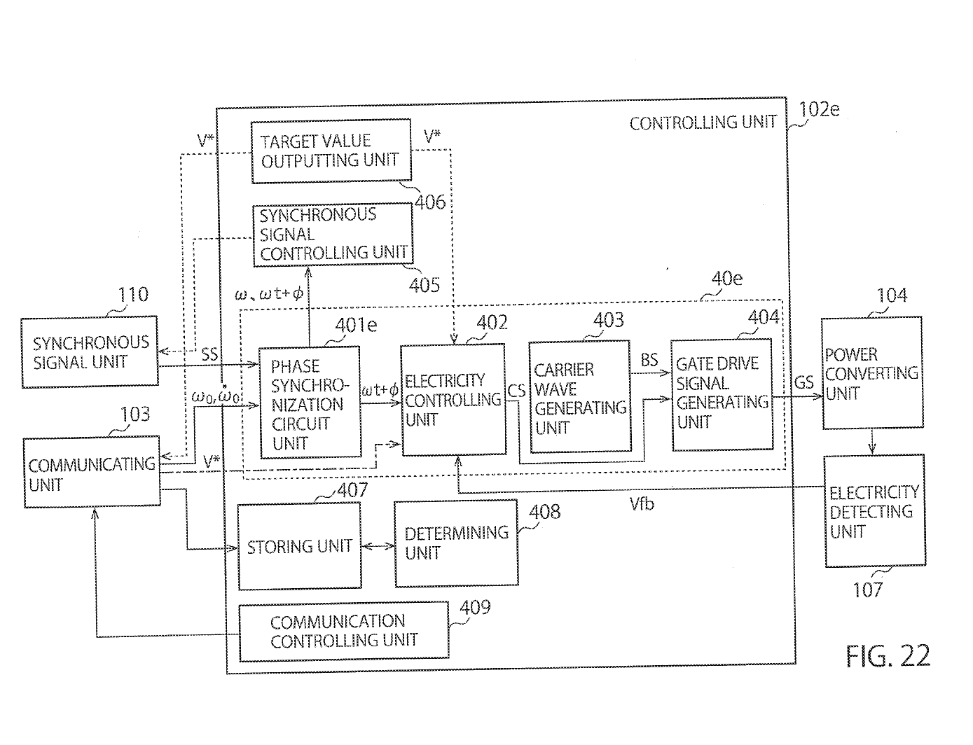

FIG. 22 is a schematic block diagram showing the configuration of the controlling unit 102e according to the fifth embodiment. Here, the same reference characters are assigned to elements in common with FIG. 10, and the concrete explanations are omitted. Compared to the configuration of the controlling unit 102 according to the first embodiment, in the configuration of the controlling unit 102e according to the fifth embodiment, the phase synchronization circuit unit 401 is changed into the phase synchronization circuit unit 401e, and because of this, the power phase controlling unit 40 is changed into a power phase controlling unit 40e.

Unlike the phase synchronization circuit unit 401 according to the first embodiment, the phase synchronization circuit unit 401e is electrically connected with the output of the communicating unit 103, and acquires the frequency information (for example, the feed-forward value “ω₀”) and the velocity change information (for example, the time-differential value of the feed-forward value “ω₀”) from the communicating unit 103.

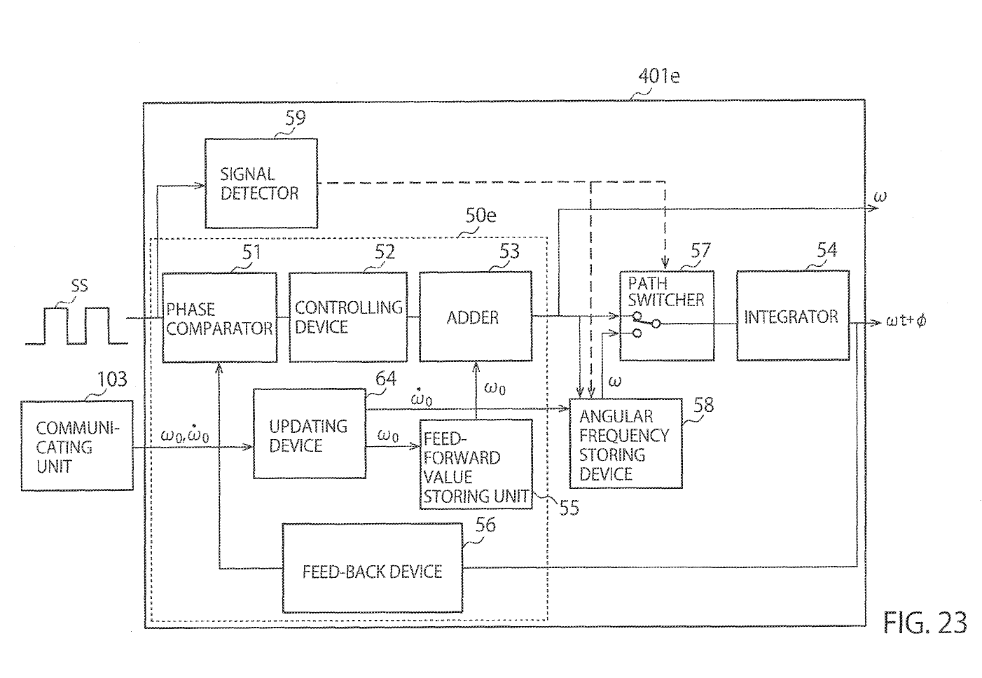

FIG. 23 is a schematic block diagram showing the configuration of the phase synchronization circuit unit 401e according to the fifth embodiment. Here, the same reference characters are assigned to elements in common with FIG. 14, and the concrete explanations are omitted. Compared to the configuration of the phase synchronization circuit unit 401b according to the second embodiment, in the configuration of the phase synchronization circuit unit 401e according to the fifth embodiment, an updating device (updating unit) 64 is further added, and because of this, the angular frequency detecting unit 50 is changed into an angular frequency detecting unit 50e.

The updating device 64 updates the angular frequency “ω” stored in the angular frequency storing device 58, based on the velocity change information (here, the time-differential value of the feed-forward value “ω₀”, as an example) acquired by the communicating unit 103.

Further, the updating unit 64 updates the feed-forward value “ω₀” stored in the feed-forward value storing unit 55, with the frequency information (here, the feed-forward value “ω₀”, as an example) acquired by the communicating unit 103.

Here, as explained in the fifth embodiment, the updating device 64 may output the data (for example, the angular frequency and the differential value) received from the communicating unit 103, with no change. Further, the updating device 64 may perform the integral of the received data (for example, the first order differential value of the angular frequency and the second order differential value of the angular frequency), or the like, to output it. Further, the updating device 64 may perform a control such as a PI control, for the data received from the communicating unit 103, and output the control result. When the updating device 64 itself has a controlling system in this way, it is possible to perform such an update that the feed-forward value stored in the feed-forward value storing unit 55 and the angular frequency “ω” stored in the angular frequency storing device 58 smoothly changes with time.

Further, the update of the feed-forward value “ω₀” and angular frequency “ω” may be performed only when the synchronous signal is disrupted, or may be performed as a part of the ordinary control.

### <Example of Communication Message>

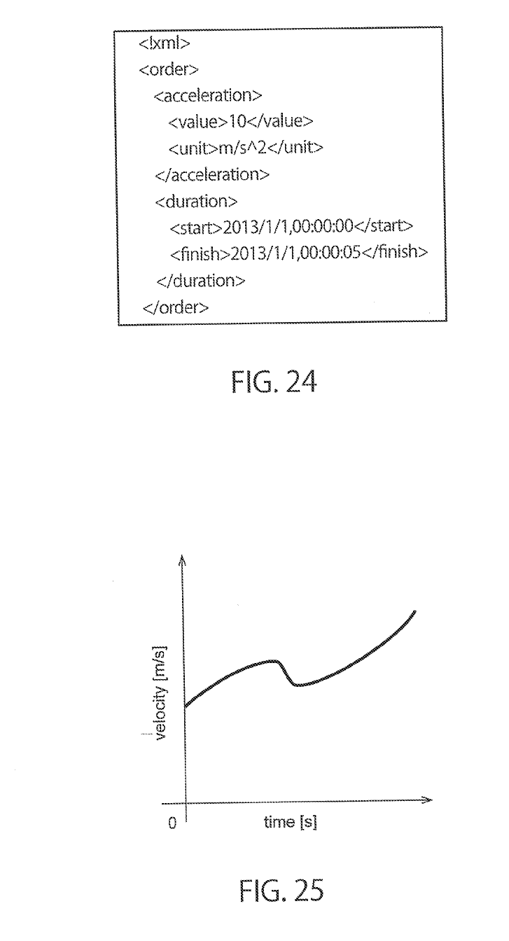

FIG. 24 is an example of the communication content for designating the duration of accelerating and decelerating. Here, the designation is transferred using XML (Extensible Markup Language), and contains the information of an acceleration and a start time and finish time for the acceleration. Besides these, a designation regarding a behavior after the acceleration is finished, or the information such as the upper limit and lower limit of the velocity may be contained.

FIG. 25 is an example of a graph that the master, the controller or the like distributes to the other inverters through communication and that shows a schedule of the velocity change after the time point of the communication occurrence. The ordinate indicates the velocity and the abscissa indicates the time. Although the ordinate indicates the velocity in this graph, the ordinate may indicate the displacement, the acceleration or the like. In addition, the communication of contents other than the above may be performed.

### Effect of Fifth Embodiment

In addition to the fourth embodiment, in the fifth embodiment, the communicating unit 103 acquires the velocity change information by communication. The updating device 64 updates the information regarding the angular frequency that is stored in the angular frequency storing device 58, based on the velocity change information acquired by the communicating unit 103. Thereby, when the synchronous signal is disrupted, the phase synchronization circuit unit 401e can update the information regarding the angular frequency, in response to the velocity change information that the communicating unit 103 acquires in advance by communication, and can output the phase in response to the updated information regarding the angular frequency. Therefore, in addition to the effects of the fourth embodiment, the power converting apparatus 10d can maintain the synchronization by the self-operation that takes into account the accelerating and decelerating of the angular frequency “ω”, when the synchronous signal is disrupted.

In other words, when the synchronous signal is disrupted, the phase synchronization circuit unit 401e changes the frequency based on the velocity change information acquired in advance by communication, and thereby, it is possible to implement the continuation of the advanced output synchronization, even while the phase synchronization circuit unit 401e is in the self-operation state. Thus, the phase synchronization circuit unit 401e performs the self-operation, and therewith, meanwhile, selects a new master using communication, to resume the sending of the synchronous signal. Thereby, it is possible to implement the nonstop continuous operation of the power converting system.

Here, the designations regarding the velocity change do not need to be in XML or an image-form table, and may be binary data, an original-form massage, a numerical data aggregate such as CVS, or a figure expressed in a form such as PostScript or SVG (Scalable Vector Graphics), which manages images in a vector form. Needless to say, whatever data form is used for performing communication, the power converting apparatus 10e according to the fifth embodiment can be configured.

Further, the apparatus to distribute the velocity change information stored in the updating device 64 by communication is not necessarily the power converting apparatus that is the master. For example, a system configuration by three kinds of apparatus: a controller to designate the frequency and velocity change information, a maser to send the synchronous signal in response to the designation from the controller, and a slave to receive the designation of the frequency from the controller and to receive the synchronous signal from the master, is also possible.

### Sixth Embodiment

Next, a sixth embodiment will be explained. A power converting apparatus according to the sixth embodiment has a secondary power line network by which the power only for driving a control microcomputer and a communication microcomputer (sometimes, referred to as a controlling system, collectively) is shared among power converting apparatuses, separately from the power line (hereinafter, sometimes, referred to as the main power line, for distinction) network to be used for power transmission.

The power to be shared by the secondary power line is a backup power source for control and communication, leading to an enhancement of the redundancy of the system. Particularly, the synchronous signal has power, and thereby, the power is transmitted through the synchronous signal line, allowing for the utilization as a driving power source in the controlling system.

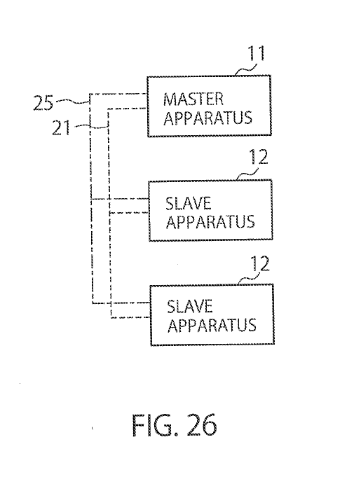

FIG. 26 is an example of a connection diagram of the main power line and secondary power line of the power converting apparatus according to the sixth embodiment. The master apparatus 11 and two slave apparatuses 12 are connected through a power line (main power line) 21 and a secondary power line 25 different from the power line 21. The network topologies of the power line 21 and secondary power line 25 may be equal, or may be different. Here, other than the configuration example of FIG. 26, the controller 13 may be connected with the multiple power converting apparatuses 10 through the power line (main power line) 21 and the secondary power line 25 different from the power line 21. In that case, the secondary power line network may include the controller 13.

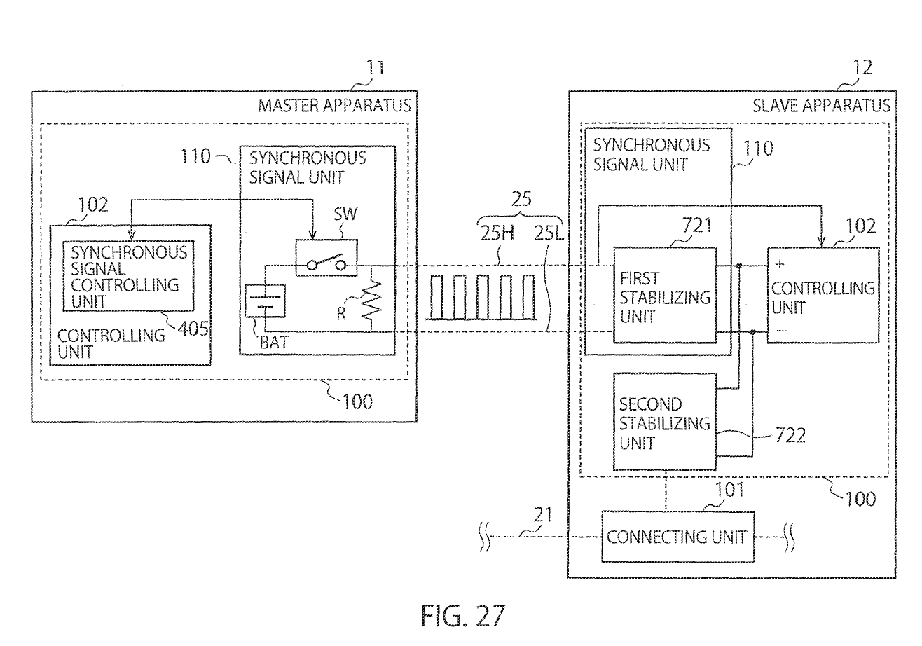

FIG. 27 is a diagram for explaining a process of the power converting apparatus 10 according to the sixth embodiment. Here, constituent elements that mainly operate when the power converting apparatus 10 operates as the master apparatus 11, and constituent elements that mainly operate when it operates as the slave apparatus 12 are shown. However, a single power converting apparatus 10 includes both the constituent elements included in the master apparatus 11 and the constituent elements included in the slave apparatus 12.

### <Outline of Configuration>

The secondary power line 25 is constituted by a first potential line 25H and a second potential line 25L. The secondary power line 25 concurrently serves as the synchronous signal line 24 for transmitting the synchronous signal. Therefore, in the embodiment, the secondary power line 25 is limited to a wire that can transmit electric signals.

The controlling apparatus to operate as the master and the controlling apparatuses to operate as the slave that receives the synchronous signal are connected through the secondary power line 25.

The controlling apparatus 100 included in the power converting apparatus 10 includes a first stabilizing unit (stabilizing unit) 721 that converts an alternating current signal to be supplied through the secondary power line 25, into a direct current voltage. Here, as an example, the first stabilizing unit 721 is included in the synchronous signal unit 110. However, the first stabilizing unit 721 may be at the exterior of the synchronous signal unit 110, and may have the input electrically connected with the synchronous signal unit 110 and have the output connected with the controlling unit 102.

When the controlling apparatus 100 in question operates as the master, the synchronous signal unit 110 outputs, to the secondary power line, the synchronous signal or a regulated signal in which the amplitude of the synchronous signal has been regulated.

On the other hand, when the controlling apparatus 100 in question operates as the slave, the first stabilizing unit 721 converts the above synchronous signal or regulated signal supplied from the master, into a direct current voltage, and the power phase controlling unit 40 uses the direct current voltage after the conversion by the first stabilizing unit 721, as a driving power source.

The controlling apparatus 100 included in the power converting apparatus 10 further includes a second stabilizing unit 722 that converts the alternating current voltage supplied from the power line 21 through the connecting unit 101, into a direct current voltage. Then, the output of the first stabilizing unit 721 and the output of the second stabilizing unit 722 are electrically connected.

The synchronous signal unit 110 has a first electrode connected with the second potential line 25L, and includes a power source BAT that generates a direct current voltage.

Furthermore, the synchronous signal unit 110 includes a switching unit SW that switches between the conduction and non-conduction of a second electrode of the power source BAT to the first potential line 25H. For example, the first electrode is cathode and the second electrode is anode.

Furthermore, the synchronous signal unit 110 includes a resistance R that has one end connected with the first potential line 25H and has the other end connected with the second potential line 25L and the first electrode of the power source BAT. Here, when the synchronous signal stops, the potential difference between the first potential line 25H and the second potential line 25L becomes 0 by the resistance R. The resistance R is, for example, a pull-down resistor having a high resistance value.

The controlling unit 102 includes a synchronous signal controlling unit 405 that controls the switching unit SW.

When the controlling apparatus in question operates as the master, the synchronous signal controlling unit 405 transmits the synchronous signal from the switching unit SW through the first potential line 25H and the second potential line 25L.

### <Details of Process>

Next, details of the process will be explained.

In the master apparatus 11, the synchronous signal controlling unit 405 included in the controlling unit 102 controls the synchronous signal unit 110 such that it outputs the synchronous signal to the slave apparatus 12 through the secondary power line 25.

Here, the master apparatus 11 may be a controller instead of an inverter.

Here, the synchronous signal may be generated by the synchronous signal controlling unit 405. On this occasion, the phase information to be used for the control by the controlling apparatus to operate as the master is obtained from the synchronous signal unit included in the controlling apparatus to operate as the master. In that case, the synchronous signal unit 110 may control the switching unit SW, using the synchronous signal generated by the synchronous signal controlling unit 405. Thereby, the switching unit SW, by switching the power to be supplied from the power source BAT, may supply the synchronous signal having the power, to the slave apparatus 12.

In the slave apparatus 12, the first stabilizing unit 721 extracts stable power from the synchronous signal transmitted through the secondary power line 25, and thereby, can be a driving power source for a microcomputer and other peripheral devices, which are actual bodies of the controlling unit 102 and the communicating unit 103. For example, the first stabilizing unit 721 is configured by one or more of a low pass filter, a regulator, a power transforming apparatus such as a voltage inverter, a small size storage battery and the like.

Particularly, when the synchronous signal has a pulse waveform, a sine wave or a form of the information communication using these waveforms and the duty ratio of the signal matches with the driving power source voltage VCC of the control microcomputer, the first stabilizing unit 721 can be configured by only the low pass filter, allowing for a simple configuration.

### Effect of Sixth Embodiment

Typically, the power converting apparatus (for example, an inverter) uses, as a power source of the controlling system, the power in which the power obtained from the power line 21 (for example, the input power line 21a or output power line 21b in FIG. 3) has been transformed or stabilized in the second stabilizing unit 722, or the power obtained from an outlet or the like. In the sixth embodiment, in addition to this, the power converting apparatuses are connected with each other through the secondary power line 25, and thereby, it is possible to secure the redundancy of the power source in the controlling system.

Further, since the secondary power line 25 concurrently serves as the synchronous signal line, it is possible to reduce the wiring and to reduce the labor in the assembly process and the maintenance.

### Seventh Embodiment

Next, a seventh embodiment will be explained. Compared to the sixth embodiment, in the seventh embodiment, the synchronous signal to be transmitted is superimposed on a direct current voltage (referred to as an offset voltage, also). Thereby, secondary power is supplied, and the detection of the presence or absence of the synchronous signal becomes easy. In other words, the detection of the disruption of the synchronous signal becomes easy.

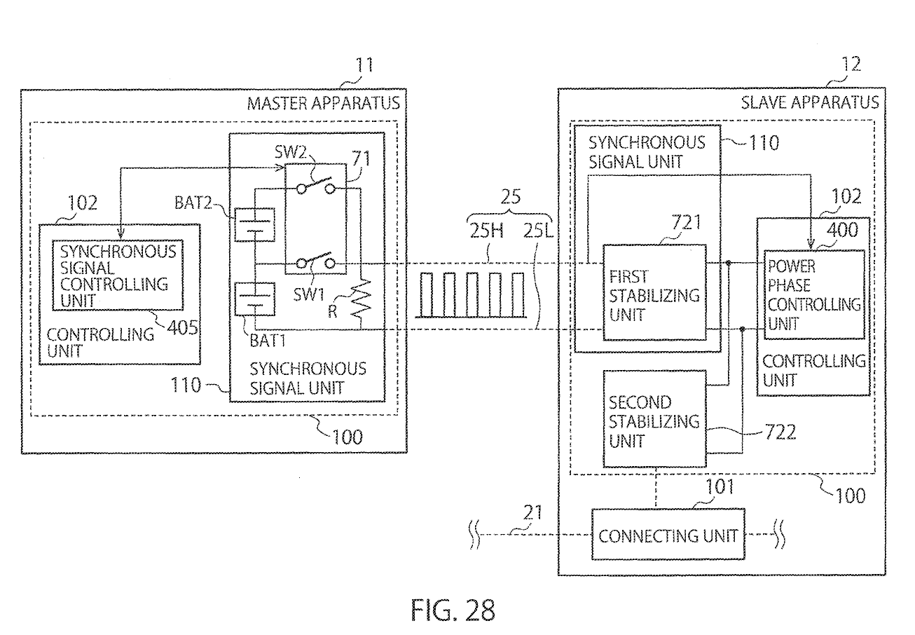

FIG. 28 is a diagram for explaining a process of a power converting apparatus 10 according to the seventh embodiment. Here, constituent elements that mainly operate when the power converting apparatus 10 operates as the master apparatus 11, and constituent elements that mainly operate when it operates as the slave apparatus 12 are shown. However, a single power converting apparatus 10 includes both the constituent elements included in the master apparatus 11 and the constituent elements included in the slave apparatus 12.

### <Explanation of Configuration>

The controlling unit 102 includes the synchronous signal controlling unit 405 that controls the synchronous signal unit 110. When the power converting apparatus 10 in question (or the controlling apparatus 100 included in the power converting apparatus 10) operates as the master, the synchronous signal controlling unit 405 superimposes the synchronous signal on a previously determined offset voltage, to generate a regulated signal, and transmits the generated regulated signal through the secondary power line 25.

The secondary power line 25 is constituted by the first potential line 25H and the second potential line 25L.

The synchronous signal unit 110 has a first electrode connected with the second potential line 25L, and includes a first power source BAT1 that generates an offset voltage.

Furthermore, the synchronous signal unit 110 includes a second power source BAT2 that has a first electrode connected with a second electrode of the first power source BAT1 and generates a direct current voltage equal to the voltage difference between the high-level and low-level of the synchronous signal. For example, the first electrode of the first power source BAT1 is cathode and the second electrode of the first power source BAT1 is anode.

Furthermore, the synchronous signal unit 110 includes a signal superimposing unit 71.

The signal superimposing unit 71 includes a first switching unit SW1 that switches between the conduction and non-conduction of the second electrode of the first power source BAT1 to the first potential line 25H.

Furthermore, the signal superimposing unit 71 includes a second switching unit SW2 that switches between the conduction and non-conduction of a second electrode of the second power source BAT2 to the first potential line 25H that transmits the synchronous signal. For example, the first electrode of the second power source BAT2 is cathode and the second electrode of the second power source BAT2 is anode.

Furthermore, the synchronous signal unit 110 includes a resistance R that has one end connected with the first potential line 25H and has the other end connected with the second potential line 25L and the first electrode of the first power source BAT1. Here, when the synchronous signal stops, the potential difference between the first potential line 25H and the second potential line 25L becomes 0 by the resistance R. The resistance R is, for example, a pull-down resistor having a high resistance value.

When the controlling apparatus 100 in question operates as the master, the synchronous signal controlling unit 405 controls the first switching unit SW1 and the second switching unit SW2 to transmit the regulated signal through the first potential line 25H and the second potential line 25L.

When the controlling apparatus 100 in question is not the master (that is, it is the slave), the power phase controlling unit 40 extracts the synchronous signal by removing direct current voltage components converted by the first stabilizing unit 721 from the regulated signal, and controls the phase of the power to be output by the power converting apparatus 10, based on the extracted synchronous signal.

### <Details of Process>

The first power source BAT1, which generates the offset voltage, generates a direct current voltage “V2a”, for example. The second power source BAT2, which generates the voltage for the synchronous signal, generates a direct current voltage “V2b”, for example.

On this occasion, in a first state, in which the first switching unit SW1 is in a non-conduction state in which the second electrode of the first power source BAT1 is non-conductive with the first potential line 25H and the second switching unit SW2 is in a conduction state in which the second electrode of the second power source BAT2 is conductive with the first potential line 25H to transmit the synchronous signal, the potential difference between the first potential line 25H and the second potential line 25L is “V2a+V2b”.

On the other hand, in a second state, in which the first switching unit SW1 is in a conduction state in which the second electrode of the first power source BAT1 is conductive with the first potential line 25H and the second switching unit SW2 is in a non-conduction state in which the second electrode of the second power source BAT2 is non-conductive with the first potential line 25H to transmit the synchronous signal, the potential difference between the first potential line 25H and the second potential line 25L is “V2a”.

The synchronous signal controlling unit 405 controls the first switching unit SW1 and the second switching unit SW2 such that they are either in the first state or in the second state.

For example, the synchronous signal controlling unit 405 switches the first switching unit SW1 and the second switching unit SW2 such that the ratio in the first state is a duty ratio “λ”, and thereby, supplies a regulated signal having an effective voltage “V′rms=V2a+λV2b”, to the slave apparatus 12.

On the other hand, when the controlling unit 102, synchronous signal unit 110 or other components in the master apparatus 11 fail and the operation of the master apparatus 11 is impossible, the master apparatus 11, in conjunction with this, stops the generation of the synchronous signal and the secondary power source.

The second power source BAT2 may be an alternating current voltage source, and the signal superimposing unit 71 may be a transformer or condenser for superimposing the signal on the offset voltage.

In the slave apparatus 12, the first stabilizing unit 721 performs a smoothing of the received waveform, and thereby, the power having the effective voltage “V′rms” is supplied to the controlling unit 102. On this occasion, the first stabilizing unit 721 further may perform the power transformation with a step-up/step-down regulator or the like.

Further, the controlling unit 102 receives the regulated signal as the output from the synchronous signal unit 110. The controlling unit 102 may directly receive the regulated signal by the wire connection with the secondary power line 25, or an insulation circuit may be provided therebetween. Further, the controlling unit 102, from the regulated signal, takes the difference from the effective voltage “V′rms” input from the first stabilizing unit, and thereby, can extract the synchronous signal regardless of the magnitude of the offset voltage “V2a”.

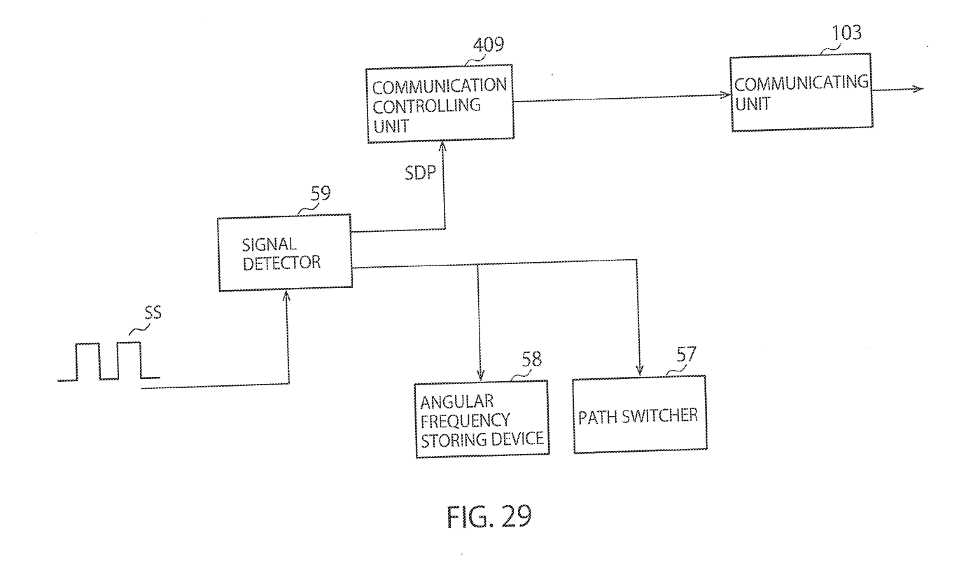

FIG. 29 is a diagram showing an information flow from the disruption of the synchronous signal to the start of the communication for the master-slave reconfiguration. The signal detector 59 detects the presence or absence of the synchronous signal. Particularly, when the offset voltage is sufficiently superimposed on the synchronous signal, for example, only whether a regulated signal voltage “V_{signal}” to be input from the first stabilizing unit 721 is greater than a threshold voltage “V_{threshold}” is monitored. Thereby, it is possible to detect the presence or absence of the synchronous signal.

When the regulated signal voltage “V_{signal}” is equal to or less than the threshold voltage “V_{threshold}”, which means the disruption of the synchronous signal, the signal detector 59 outputs a disruption notice signal “SDP” showing the disruption of the synchronous signal, to the communication controlling unit 409. Further, as described above, the signal detector 59 controls the path switcher 57 and the angular frequency storing unit 58, for example.

The communication controlling unit 409, when receiving the disruption notice signal “SDP” from the signal detector 59, recognizes that the master has stopped, and controls the communicating unit 103 to start the communication for the master-slave reconfiguration with the other power converting apparatuses through the communicating unit 103.

Here, in the above example, the master to generate the synchronous signal performs the supply of the offset voltage, also. However, it is allowable to be a configuration in which a power converting apparatus different from the master supplies the offset voltage to the synchronous signal line. In this case, the disruption of the offset voltage means the stop of the slave, and therefore, the technique shown in FIG. 29 cannot be applied with no change.

However, the power converting apparatuses other than the slave to supply the offset voltage detects the presence or absence of the synchronous signal, and thereby, can instantly detect the stop of the slave in question. For example, when the slave in question is an important apparatus in the system, there is a merit that the output of the whole system can be rapidly regulated, if the master and the other power converting apparatuses can instantly detect the stop of the slave in question.

As described above, the synchronous signal unit may receive the synchronous signal from a synchronous signal generating apparatus that generates the synchronous signal. Here, for example, the synchronous signal generating apparatus may be the controller 13 shown in FIG. 4, or may be an oscillator that has only a function to generate the synchronous signal.

In that case, the above information for determining the master is the information for determining the master among the controlling apparatus in question and one or more other controlling apparatuses of power converting apparatuses.

Further, in the case shown in FIG. 4, it can be said to configure a controlling system including multiple controlling apparatuses that control multiple power converting apparatuses, and a synchronous signal generating apparatus that generates a synchronous signal as the basis of the phases of the output powers by the power converting apparatuses and sends it to the above multiple controlling apparatuses. In that case, the synchronous signal unit included in each controlling apparatus receives the above synchronous signal from the above synchronous signal generating apparatus.

### <Angular Frequency, Form of Frequency, and the Like>

Needless to say, in the embodiments, the angular frequency “ω” and the feed-forward value “ω₀” do not necessarily require a form of angular frequency, and may be numerical values that can be equivalently replaced with “ω” by the four arithmetic operations, such as frequency “f”, “2ω” or velocity “v”, or may be another form such as a square root of “ω”. The information regarding the angular frequency contains the numerical values that can be equivalently replaced with “ω” by the four arithmetic operations, such as frequency “f”, “2ω” or velocity “v”, another form such as a square root of “ω”, and the like. To these, the embodiments can be applied, unless departing from the spirit of the embodiments. The same goes for other variables.

### <Integration of Communicating Unit, Signal Unit, Connecting Unit and the Like>

In the figures shown in the embodiments, the communicating unit, the signal unit and the connecting unit are exemplified separately. However, the embodiments can be applied to even a structure in which they are integrated, unless departing from the spirit of the embodiments. For example, when a power line communication is used for communication, the communicating unit and the connecting unit can be regarded as being connected, or as being integrated.

<Kind of Synchronous Signal and Shift, Modulation Wave (50, 60 Hz), Carrier Wave (10 kHz)>

Various power converting apparatuses such as an inverter use not only sine waves having a frequency of 50 or 60 Hz, which is the same as the frequency of a grid, but also waveforms having some frequencies such as a carrier wave to be used for a PWM control. The present invention can be applied to any of these waveforms. Even when operating while holding a certain phase angle difference without matching the waveforms among multiple power converting apparatuses, the application is possible. Such an operation method can be also seen to be a synchronous operation in a broad sense, and therefore is described as a synchronization. In such a case, an addition or removal of a function is sometimes performed in a part of the constituent elements of the power converting apparatus, such as the phase comparator.

Here, in the embodiments, the controlling apparatus is included in the power converting apparatus, but without being limited to this, the controlling apparatus may be at the exterior of the power converting apparatus.

Here, by a system including multiple apparatuses, the processes of the controlling apparatuses according to the embodiments may be distributed and processed among the multiple apparatuses.

Here, for example, the controlling apparatuses according to the embodiments can be implemented also by using a general-purpose computer apparatus as basic hardware. That is, a processor mounted in the above computer apparatus executes a program for executing the processes of the controlling apparatuses according to the embodiments, allowing for the implementation.

On this occasion, it is allowable that the above program is previously installed in the computer apparatus, and thereby the controlling apparatuses according to the embodiments are implemented. Further, it is allowable that the above program is distributed through a portable medium such as a CD-ROM or a communication network, the computer apparatus reads the program, the processor executes the above program, and thereby, the above described various processes involved in the controlling apparatuses are performed.

Thus, it is allowable that the program for executing the processes of the controlling apparatuses according to the embodiments is recorded in a computer-readable recording medium, a computer system reads the program recorded in the recording medium, the processor executes it, and thereby, the above described various processes involved in the controlling apparatuses according to the embodiments are performed.

The “computer system” herein may include an OS and hardware such as peripheral apparatuses. Further, when utilizing a WWW system, the “computer system” includes a home page providing environment (or displaying environment), also. Further, the “computer-readable recording medium” is a storing apparatus including a writable nonvolatile memory such as a flexible disk, a magneto-optical disk, a ROM or a flash memory, a portable medium such as a CD-ROM, a CD-RW, a DVD-RAM or a DVD-R, a hard disk that is incorporated in or externally attached to the computer system, or a memory.

In addition, the “computer-readable recording medium” includes a medium to hold a program for a certain time, for example, a volatile memory (for example, a DRAM (Dynamic Random Access Memory)) within a computer system that is a server or a client when a program is sent through a network such as the Internet or a communication circuit such as a telephone circuit.

Further, the above program may be transmitted from a computer system in which the program is stored in a storing medium or the like, to another computer system, through a transmission medium or by a transmission wave in a transmission medium. Here, the “transmission medium” for transmitting the program means a medium having a function to transmit information, as exemplified by a network (communication network) such as the Internet, and a communication circuit (communication line) such as a telephone circuit. Further, the above program may implement a part of the above described functions, and moreover, may be a so-called differential file (differential program) that can implement the above described functions by a combination with programs stored in the computer system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A controlling apparatus to control a power converting apparatus that converts power and outputs the converted power to a power line, the controlling apparatus comprising:
a communicating unit to communicate with at least one other controlling apparatus for a power converting apparatus that outputs power to the power line;
a synchronous signal unit to receive a synchronous signal that is a basis of a phase of the output power by the power converting apparatus;
a power phase controlling unit to control the phase of the power to be output to the power line by the power converting apparatus, based on the synchronous signal, and when a disruption of the synchronous signal is detected, control the phase of the power to be output to the power line by the power converting apparatus, based on the synchronous signal received before the disruption; and
a communication controlling unit to control the communicating unit such that, for information to determine a master that sends the synchronous signal, the communicating unit performs either one of a receiving from the controlling apparatus for the other power converting apparatus and a sending to the controlling apparatus for the other power converting apparatus, while the power phase controlling unit performs the control based on the synchronous signal received before the disruption.

2. The controlling apparatus according to claim 1, further comprising
a determining unit to determine a controlling apparatus that operates as a new master, based on the information to determine the master that the communicating unit receives from the controlling apparatus for the other power converting apparatus, while the power phase controlling unit performs the control based on the synchronous signal before the disruption.

3. The controlling apparatus according to claim 2,
wherein the synchronous signal unit sends the synchronous signal to the other controlling apparatus, when the controlling apparatus in question is the controlling apparatus determined as the new master by the determining unit.

4. The controlling apparatus according to claim 1,
wherein the power phase controlling unit comprises a phase synchronization circuit unit to perform such a control to reduce a difference between a phase of the synchronous signal received before the disruption and a phase to be output, and controls the phase of the power to be output by the power converting apparatus, based on the phase output by the phase synchronization circuit unit.

5. The controlling apparatus according to claim 4,
wherein the phase synchronization circuit unit comprises:
an angular frequency detecting unit to detect information regarding an angular frequency, based on the synchronous signal;
a signal detecting unit to detect whether or not the synchronous signal is disrupted;
an angular frequency storing unit to update stored information regarding the angular frequency, with the information regarding the angular frequency detected by the angular frequency detecting unit, while the signal detecting unit detects that the synchronous signal is not disrupted; and
an integrating unit to acquire the information regarding the angular frequency from the angular frequency storing unit and generate the phase to be output based the acquired information regarding the angular frequency, when the signal detecting unit detects the disruption of the synchronous signal, and
the power phase controlling unit controls the phase of the power to be output by the power converting apparatus, based on the phase generated by the integrating unit.

6. The controlling apparatus according to claim 5,
wherein the phase synchronization circuit unit further comprises:
a velocity change generating unit to generate velocity change information regarding temporal change in the angular frequency generated by the angle frequency detecting unit;
a velocity change storing unit to update stored velocity change information, with the velocity change information generated by the velocity change generating unit, while the signal detecting unit detects that the synchronous signal is not disrupted; and
an updating unit to start updating the information regarding the angular frequency stored in the angular frequency storing unit, with the velocity change information stored in the velocity change storing unit, when the signal detecting unit detects the disruption of the synchronous signal.

7. The controlling apparatus according to claim 5,
wherein the communicating unit acquires velocity change information regarding temporal change in the angular frequency of the synchronous signal by communication, and
the phase synchronization circuit unit comprises an updating unit to update the information regarding the angular frequency stored in the angular frequency storing unit, based on the velocity change information acquired by the communicating unit.

8. The controlling apparatus according to claim 4,
wherein the communicating unit acquires frequency information regarding a frequency of the power to be output by the power converting apparatus, at multiple times by communication, and
the phase synchronization circuit unit comprises:
an angular frequency detecting unit to generate information regarding an angular frequency, based on the synchronous signal and the frequency information acquired by the communicating unit; and
an integrating unit to generate the phase to be output, based on the information regarding the angular frequency generated by the angular frequency detecting unit, and
the power phase controlling unit controls the phase of the power to be output by the power converting apparatus, based on the phase generated by the integrating unit.

9. The controlling apparatus according to claim 1,
wherein the synchronous signal unit receives the synchronous signal from the controlling apparatus that operates as the master to send the synchronous signal, and
the information to determine the master is information to determine the master among controlling apparatuses other than the controlling apparatus that operates as the master.

10. The controlling apparatus according to claim 9,
wherein the controlling apparatus that operates as the master is connected through a secondary power line, with a controlling apparatus that operates as a slave to receive the synchronous signal,
the controlling apparatus comprises a stabilizing unit to convert an alternating current signal into a direct current voltage, the alternating current signal being supplied through the secondary power line,
when the controlling apparatus in question operates as the master, the synchronous signal unit outputs the synchronous signal or a regulated signal to the secondary power line, the regulated signal being a signal in which an amplitude of the synchronous signal has been regulated, and
when the controlling apparatus in question is the controlling apparatus that operates as the slave,
the stabilizing unit converts the synchronous signal or the regulated signal supplied from the master, into the direct current voltage, and
the power phase controlling unit uses the direct current voltage after the conversion by the stabilizing unit, as a driving power source.

11. The controlling apparatus according to claim 10, further comprising
a second stabilizing unit to convert an alternating current voltage supplied through the power line into a direct current voltage,
wherein an output of the stabilizing unit and an output of the second stabilizing unit are electrically connected.

12. The controlling apparatus according to claim 10,
wherein the secondary power line includes a first potential line and a second potential line,
the synchronous signal unit further comprises:
a power source having a first electrode connected with the second potential line and to generate a direct current voltage;
a switching unit to switch between conduction and non-conduction of a second electrode of the power source to the first potential line; and
a resistance having one end connected with the first potential line and having the other end connected with the second potential line and the first electrode of the power source,
the controlling apparatus further comprises a synchronous signal controlling unit to control the switching unit, and
when the controlling apparatus in question operates as the master, the synchronous signal controlling unit transmits the synchronous signal from the switching unit through the first potential line and the second potential line.

13. The controlling apparatus according to claim 10, further comprising
a synchronous signal controlling unit to control the synchronous signal unit,
wherein, when the controlling apparatus in question operates as the master, the synchronous signal unit superimposes the synchronous signal on a previously determined offset voltage, to generate the regulated signal, and transmits the generated regulated signal through the secondary power line.

14. The controlling apparatus according to claim 13,
wherein the secondary power line includes a first potential line and a second potential line,
the synchronous signal unit comprises:
a first power source having a first electrode connected with the second potential line and to generate the offset voltage;
a second power source having a first electrode connected with a second electrode of the first power source and to generate a direct current voltage equal to a voltage difference between a high-level and low-level of the synchronous signal;
a first switching unit to switch between conduction and non-conduction of the second electrode of the first power source to the first potential line;
a second switching unit to switch between conduction and non-conduction of a second electrode of the second power source to the first potential line that transmits the synchronous signal; and
a resistance having one end connected with the first potential line and having the other end connected with the second potential line and the first electrode of the first power source, and
the controlling apparatus further comprises a synchronous signal controlling unit to control the first switching unit and the second switching unit and transmit the regulated signal through the first potential line and the second potential line, when the controlling apparatus in question operates as the master.

15. The controlling apparatus according to claim 13,
wherein, when the controlling apparatus in question operates as the slave,
the power phase controlling unit extracts the synchronous signal by removing a direct current voltage component converted by the stabilizing unit from the regulated signal, and controls the phase of the power to be output by the power converting apparatus, based on the extracted synchronous signal.

16. The controlling apparatus according to claim 1,
wherein the synchronous signal unit receives the synchronous signal from a synchronous signal generating apparatus that generates the synchronous signal, and
the information to determine the master is information to determine the master among the controlling apparatus in question and the at least one other controlling apparatus for the power converting apparatus.

17. A power converting apparatus comprising:
the controlling apparatus according to claim 1; and
a power converting unit to convert input power and then output the converted power to the power line.

18. A controlling method to be executed by a controlling apparatus to control a power converting apparatus that converts power and outputs the converted power to a power line, the controlling apparatus comprising: a communicating unit to communicate with at least one other controlling apparatus for a power converting apparatus that outputs power to the power line; and a synchronous signal unit to receive a synchronous signal that is a basis of a phase of the output power by the power converting apparatus,
the controlling method comprising:
a power phase controlling unit controlling the phase of the power to be output to the power line by the power converting apparatus, based on the synchronous signal;
when the power phase controlling unit detects a disruption of the synchronous signal, controlling the phase of the power to be output to the power line by the power converting apparatus, based on the synchronous signal received before the disruption; and
a communication controlling unit controlling the communicating unit such that, for information to determine a master that sends the synchronous signal, the communicating unit performs either one of a receiving from the controlling apparatus for the other power converting apparatus and a sending to the controlling apparatus for the other power converting apparatus, while the power phase controlling unit performs the control based on the synchronous signal received before the disruption.

19. A computer-readable recording medium storing a program to be executed by a controlling apparatus to control a power converting apparatus that converts power and outputs the converted power to a power line, the controlling apparatus comprising: a communicating unit to communicate with at least one other controlling apparatus for a power converting apparatus that outputs power to the power line; and a synchronous signal unit to receive a synchronous signal that is a basis of a phase of the output power by the power converting apparatus,
the program causes the controlling apparatus to execute:
a first step of controlling the phase of the power to be output to the power line by the power converting apparatus, based on the synchronous signal;
a second step of, when a disruption of the synchronous signal is detected, controlling the phase of the power to be output to the power line by the power converting apparatus, based on the synchronous signal received before the disruption; and
a third step of controlling the communicating unit such that, for information to determine a master that sends the synchronous signal, the communicating unit performs either one of a receiving from the controlling apparatus for the other power converting apparatus and a sending to the controlling apparatus for the other power converting apparatus, while performing the control based on the synchronous signal received before the disruption in the second step.

20. A controlling system including: multiple controlling apparatuses to control multiple power converting apparatuses; and a synchronous signal generating apparatus to generate a synchronous signal that is a basis of a phase of an output power by the power converting apparatus and to send the synchronous signal to the multiple controlling apparatuses,
wherein each of the controlling apparatuses comprises:
a communicating unit to communicate with at least one other controlling apparatus for a power converting apparatus that outputs power to the power line;
a synchronous signal unit to receive the synchronous signal from the synchronous signal generating apparatus;
a power phase controlling unit to control the phase of the power to be output to the power line by the power converting apparatus, based on the synchronous signal, and when a disruption of the synchronous signal is detected, control the phase of the power to be output to the power line by the power converting apparatus, based on the synchronous signal received before the disruption; and
a communication controlling unit to control the communicating unit such that, for information to determine a master that sends the synchronous signal, the communicating unit performs either one of a receiving from the controlling apparatus for the other power converting apparatus and a sending to the controlling apparatus for the other power converting apparatus, while the power phase controlling unit performs the control based on the synchronous signal received before the disruption.
